(19) United States
(12) Patent Application Publication
(10) Pub. No.: US 2021/0079293 A1
(43) Pub. Date: Mar. 18, 2021

(54) METHODS OF PRODUCING COATED PROPPANTS

(71) Applicant: Saudi Arabian Oil Company, Dhahran (SA)

(72) Inventors: Rajesh Kumar Saini, Cypress, TX (US); Mohammad Hamidul Haque, Katy, TX (US); Scott Douglas Allen, Ithaca, NY (US)

(73) Assignee: Saudi Arabian Oil Company, Dhahran (SA)

(21) Appl. No.: 16/573,504

(22) Filed: Sep. 17, 2019

(51) Int. Cl. C09K 8/80; C08G 18/44; C08G 18/48; C08G 18/32; C08G 18/66; C08G 18/18; C08G 18/76; C08G 18/83

(52) U.S. Cl. CPC C09K 8/805; C08G 18/44; C08G 18/4887; C08G 18/3206; C08G 18/83; C08G 18/6674; C08G 18/1808; C08G 18/7671; C08G 18/664

(57) ABSTRACT

Methods for producing proppants with a polyurethane proppant coating are provided. The methods include forming aliphatic polycarbonate polyols from the copolymerization of epoxide and CO₂ monomers, forming the polyurethane proppant coating by reacting the aliphatic polycarbonate polyols and at least one of diisocyanate monomers and isocyanate monomers, and coating proppant particles with the polyurethane proppant coating to produce coated proppants with polyurethane proppant coating.

### TECHNICAL FIELD

Embodiments of the present disclosure generally relate to methods of producing coated proppants.

### BACKGROUND

Hydraulic fracturing is a stimulation treatment routinely performed on oil and gas wells. Hydraulic fracturing fluids are pumped into the subsurface formation to be treated, causing fractures to open in the subsurface formation. Proppants, such as grains of sand, may be mixed with the treatment fluid to keep the fracture open when the treatment is complete.

### SUMMARY

It is often desirable during and after fracturing a subsurface formation to hold the fractures open through the use of proppants for more effective oil and gas production than without. However, sand particles, which are used as proppants, may not provide sufficient crush resistance for use in a given subsurface formation due to the polycrystalline nature of the grains. Conventional uncoated proppants break under downhole stress. Ceramic proppants break down in wet conditions, which cause them to lose their crush resistance. Temperatures downhole exacerbate this effect.

Proppant coatings are used to protect the proppant particle from degradation by the presence of aqueous fluids at downhole temperatures. The proppant coating increases the surface area of the particle; therefore, the crush stress is distributed over a greater area of the coated proppant particle. In turn, the distribution of force along a greater area should result in a decrease in the amount of crushed proppant particles, also known as ‘the crush percentage.’ The proppant coating also adheres to the proppant and prevents proppants that are crushed upon application of formation stress from releasing proppant fines. Proppant fines may migrate into the formation and restrict flow conductivity of the formation.

Accordingly, a need exists for a strong proppant coating. The present disclosed subject matter and embodiments address this need by providing a polyurethane proppant coating that provides increased hardness and tensile strength to the proppant particles as compared to conventional proppant coating leading to less degradation downhole. The polyurethane proppant coating of this disclosure further exhibits an increased glass transition temperature as compared to conventional proppant coatings.

According to the subject matter of the present disclosure, a method for producing proppant particles coated with polyurethane is disclosed. The method includes forming aliphatic polycarbonate polyols from the copolymerization of epoxide and CO₂ monomers. The method also includes forming the polyurethane proppant coating by reacting the aliphatic polycarbonate polyols with at least one of diisocyanate monomers, diisocynate oligomers, diisocynate polymers, polyisocyanate monomers, polyisocyanate oligomers, orpolyisocyanate polymers. The method also includes coating proppant particles with the polyurethane proppant coating.

In accordance with another embodiment of the present disclosure, a method for producing proppant particles coated with polyurethane is disclosed. The method includes forming the polyurethane proppant coating by reacting at least one of diisocyanate monomers, diisocynate oligomers, diisocynate polymers, polyisocyanate monomers, polyisocyanate oligomers, or polyisocyanate polymers with at least one of polycaprolactone polyols, polylactide polyols, poly(β-lactone) polyols, poly(s-lactone) polyols, polysulfide polyols, fluorinated vinyl ether polyols, siloxane polyols, or aminic polyols. The method also includes coating proppant particles with the polyurethane proppant coating.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic view of a proppant particle and a coated proppant, according to one or more embodiments described in this disclosure; and

FIG. 2 is a reaction mechanism of CO₂ epoxide copolymer formation, according to one or more embodiments described in this disclosure.

### DETAILED DESCRIPTION

As used throughout this disclosure, the term “condensate” refers to a liquid hydrocarbon phase that generally occurs in association with natural gas. Its presence as a liquid phase depends on temperature and pressure conditions in the reservoir allowing condensation of liquid from vapor. The production of condensate reservoirs can be complicated, because of the pressure sensitivity of some condensates. During production, there is a risk of the condensate changing from gas to liquid if the reservoir pressure is reduced to less than the dew point during production. Hydrocarbon gas produced in association with condensate is called wet gas. The API gravity of condensate is typically from 50° to 120°.

As used throughout this disclosure, the term “condensate banking” refers to a relative permeability effect where condensate drops out of the vapor phase around the wellbore when the pressure is reduced to less than the dew point in response to drawdown or depletion. Hydrocarbon gs production rate may be severely reduced by the permeability reduction.

As used throughout this disclosure, the term “hierarchical roughness” refers to micro roughness covered with nano roughness. This differs from unitary roughness as the material is not solely micro roughness or nano roughness, but a combination of the two. Micro roughness refers to the quality of being rough at the microscale (under 1 millimeter (mm)), and nano roughness refers to the quality of being rough at the nanoscale (under 100 nanometers (μm)).

As used throughout this disclosure, the term “hydraulic fracturing” refers to a stimulation treatment routinely performed on hydrocarbon wells. Hydraulic fracturing fluids are pumped into a subsurface formation, causing a fracture to form or open. Proppants are mixed with the treatment fluid to keep the fracture open when the treatment is complete. Hydraulic fracturing creates fluid communication with a subsurface formation and bypasses damage, such as condensate banking, that may exist in the near-wellbore area.

As used throughout this disclosure, the term “subsurface formation” refers to a body of rock that is sufficiently distinctive and continuous from the surrounding rock bodies that the body of rock can be mapped as a distinct entity. A subsurface formation is, therefore, sufficiently homogenous to form a single identifiable unit including similar rheological properties throughout the subsurface formation, including, but not limited to, porosity and permeability. A subsurface formation is the fundamental unit of lithostratigraphy.

As used throughout this disclosure, the term “lithostatic pressure” refers to the pressure of the weight of overburden, or overlying rock, on a subsurface formation.

As used throughout this disclosure, the term “producing subsurface formation” refers to the subsurface formation from which hydrocarbons are produced.

As used throughout this disclosure, the term “proppant” refers to particles mixed with hydraulic fracturing fluid to hold fractures open after a hydraulic fracturing treatment. Proppant materials are carefully sorted for mesh size, roundness and sphericity to provide an efficient conduit for fluid production from the reservoir to the wellbore.

As used throughout this disclosure, the term “reservoir” refers to a subsurface formation having sufficient porosity and permeability to store and transmit fluids.

As used throughout this disclosure, the term “wellbore” refers to the drilled hole or borehole, including the openhole or uncased portion of the well. Borehole may refer to the inside diameter of the wellbore wall, the rock face that bounds the drilled hole.

To produce hydrocarbons from a hydrocarbon-including reservoir, production wells are drilled to a depth that enables hydrocarbons to travel from the subsurface formation to the surface. However, when producing hydrocarbon gas, the wellbore and subsurface formation pressure decrease as the volume of hydrocarbon gas in the reservoir decreases. If pressure is reduced to less than the dew point of the hydrocarbon gas, condensate may form and create blockage, decreasing the permeability between the wellbore and the subsurface formation, and thereby decreasing the rate of production of the hydrocarbon gas.

The present disclosure is directed to compositions and methods for producing polyurethane coated proppants. The method may include forming aliphatic polycarbonate polyols from the copolymerization of epoxide and CO₂ monomers, and forming the polyurethane proppant coating by reacting the aliphatic polycarbonate polyols and at least one of diisocyanate monomers, diisocynate oligomers, diisocynate polymers, polyisocyanate monomers, polyisocyanate oligomers, or polyisocyanate polymers. The method may further include coating proppant particles with the polyurethane coating to produce coated proppants with polyurethane coating. Example of suitable epoxides include ethylene oxide, propylene oxide, butylene oxide, cyclohexene oxide, epichlorohydrin, glycidyl ether, glycidyl ester, phenyl glycidyl ether, t-butyl glycidyl ether, soyabene epoxide, or combinations of these.

Forming the aliphatic polycarbonate polyols from the copolymerization of epoxide and CO₂ monomers may include reacting one or more epoxide monomers and CO₂ monomers, and allowing the polymerization reaction to proceed until a desired molecular weight aliphatic polycarbonate polyol has formed and in which at least 90% of the end groups in the aliphatic polycarbonate polyol composition are hydroxyl groups. In some embodiments, at least 98% of the ends groups in the aliphatic polycarbonate polyol composition are hydroxyl groups. Finally, the forming of the aliphatic polycarbonate polyols may include terminating the polymerization.

In some embodiments, the epoxide-CO₂ copolymer includes from 40 to 99 weight percent (wt. %), from 40 to 95 wt. %, from 40 to 90 wt. %, from 40 to 85 wt. %, from 40 to 80 wt. %, from 40 to 70 wt. %, from 40 to 60 wt. %, from 40 to 50 wt. %, from 50 to 99 wt. %, from 50 to 95 wt. %, from 50 to 90 wt. %, from 50 to 85 wt. %, from 50 to 80 wt. %, from 50 to 70 wt. %, from 50 to 60 wt. %, from 60 to 99 wt. %, from 60 to 95 wt. %, from 60 to 90 wt. %, from 60 to 85 wt. %, from 60 to 80 wt. %, from 60 to 70 wt. %, from 70 to 99 wt. %, from 70 to 95 wt. %, from 70 to 90 wt. %, from 70 to 85 wt. %, from 70 to 80 wt. %, from 80 to 99 wt. %, from 80 to 95 wt. %, from 80 to 90 wt. %, from 80 to 85 wt. %, from 85 to 99 wt. %, from 85 to 95 wt. %, from 85 to 90 wt. %, from 90 to 99 wt. %, from 90 to 95 wt. %, or from 95 to 99 wt. % epoxide monomer.

In some embodiments, the epoxide-CO₂ copolymer includes from 1 to 70 wt. %, from 1 to 60 wt. %, from 1 to 50 wt. %, from 1 to 40 wt. %, from 1 to 30 wt. %, from 1 to 20 wt. %, from 1 to 10 wt. %, from 10 to 70 wt. %, from 10 to 60 wt. %, from 10 to 50 wt. %, from 10 to 40 wt. %, from 10 to 30 wt. %, from 10 to 20 wt. %, from 20 to 70 wt. %, from 20 to 60 wt. %, from 20 to 50 wt. %, from 20 to 40 wt. %, from 20 to 30 wt. %, from 30 to 70 wt. %, from 30 to 60 wt. %, from 30 to 50 wt. %, from 30 to 40 wt. %, from 40 to 70 wt. %, from 40 to 60 wt. %, from 40 to 50 wt. %, from 50 to 70 wt. %, from 50 to 60 wt. %, or from 60 to 70 wt. % CO₂ monomer.

Individual epoxide-CO₂ copolymers may have a number average molecular weight (Mn) of from 400 to 20,000. Individual epoxide-CO₂ copolymers may have greater than 90% carbonate linkages. Individual epoxide-CO₂ copolymers may have at least 98% of the end groups being hydroxyl groups.

In some embodiments, the carbonate linkage content of the epoxide-CO₂ copolymers is at least 90 wt. %. In some embodiments, greater than 92 wt. % of linkages are carbonate linkages. In some embodiments, at least 95 wt. % of linkages are carbonate linkages. In some embodiments, at least 97 wt. % of linkages are carbonate linkages. In some embodiments, greater than 98 wt. % of linkages are carbonate linkages. In further embodiments, at least 99 wt. % of linkages are carbonate linkages. In some embodiments essentially all of the linkages are carbonate linkages (in other words, there are essentially only carbonate linkages detectable by typical methods such as ¹H or ¹³C NMR spectroscopy).

In some embodiments, the reaction of CO₂ with epoxide generates polyethercarbonate polyol. The polyethercarbonate polyol reacts with at least one of diisocyanate monomers, diisocynate oligomers, diisocynate polymers, polyisocyanate monomers, polyisocyanate oligomers or polyisocyanate polymers to form the polyurethane proppant coating. In some embodiments, the ether linkage content of the epoxide-CO₂ copolymers is less than 10% to form aliphatic polyethercarbonate polyols. In some embodiments, less than 8% of linkages are ether linkages. In some embodiments, less than 5% of linkages are ether linkages. In some embodiments, no more than 3% of linkages are ether linkages. In some embodiments, fewer than 2% of linkages are ether linkages in some embodiments less than 1% of linkages are ether linkages. In some embodiments essentially none of the linkages are ether linkages (in other words, there are essentially no ether bonds detectable by typical methods such as ¹H or ¹³C NMR spectroscopy).

In some embodiments, the epoxide-CO₂ copolymers have an Mn ranging from about 400 to about 400,000 grams per mole (g/mol), in which the Mn is calculated by Gel Permeation Chromatography (GPC) analysis. In some embodiments, the epoxide-CO₂ copolymers have an Mn ranging from about 400 to about 20,000 g/mol. In some embodiments, the copolymers have an Mn between about 500 and about 5,000 g/mol. In other embodiments, the copolymers have an Mn between about 800 and about 4,000 g/mol. In some embodiments, the copolymers have an Mn between about 1,000 and about 3,000 g/mol. In some embodiments, the copolymers have an Mn of about 1,000 g/mol. In some embodiments, the copolymers have an Mn of about 2,000 g/mol. In some embodiments, the copolymers have an Mn of about 3,000 g/mol. In some embodiments, epoxide-CO₂ copolymers have about 10 to about 200 repeat units. In other embodiments, the copolymers have about 20 to about 100 repeat units.

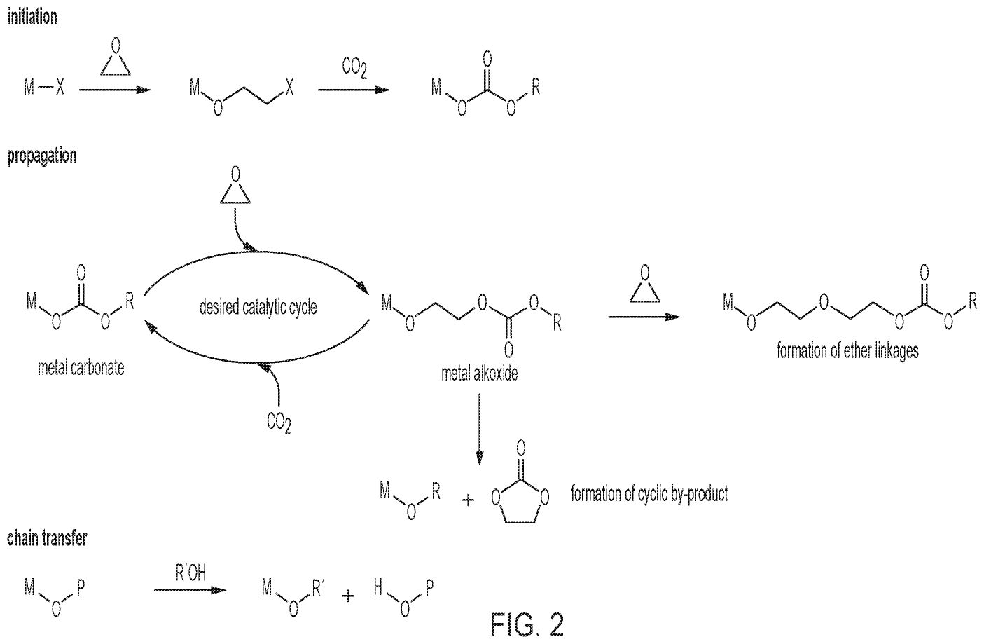

In some embodiments, the CO₂ epoxide copolymers are formed from CO₂ and one type of epoxide. FIG. 2 represents the reaction mechanism of the CO₂ epoxide copolymer formation, where M is a metal catalyst such as Zn(II), Co(III) and Cr(III), X is a ligand, and P is a polymer. The epoxide shown in FIG. 2 may be substituted to yield varying polyols. In other embodiments, the copolymers incorporate two or more types of epoxide. In some embodiments, the copolymers predominantly incorporate one epoxide, with lesser amounts of one or more additional epoxides. In some embodiments where two or more epoxides are present, the copolymer is random with respect to the position of the epoxide moieties within the chain. In other embodiments where two or more epoxides are present, the copolymer is a tapered copolymer with respect to the incorporation of different epoxides. In some embodiments where two or more epoxides are present, the copolymer is a block copolymer with respect to the incorporation of different epoxides.

In some embodiments, the polymer chains may include embedded polymerization initiators or may be a block-copolymer with a non-polycarbonate segment. In other embodiments, the polymer chains may include separate polymerization initiators. In some examples of these embodiments, the stated total carbonate content of the polymer chain may be less than the stated carbonate content limitations described in this disclosure. In these cases, the carbonate content refers only to the epoxide-CO₂ copolymeric portions of the polymer composition. In other words, a polymer may include a polyester, polyether or polyether-polycarbonate moiety embedded within or appended to it. The non-carbonate linkages in such moieties are not included in the carbonate and ether linkage limitations described in this disclosure.

In some embodiments, polycarbonate polyols are further characterized in that they have narrow polydispersity (Molecular weight divided by Molecular number (Mw/Mn)) as calculated by GPC. In some embodiments, the polydispersity (PDI) of the provided polymer compositions is less than 2. In some embodiments, the PDI is less than 1.5. In other embodiments, the PDI is less than about 1.4. In some embodiments, the PDI is less than about 1.2. In other embodiments, the PDI is less than about 1.1. In some embodiments, the polycarbonate polyol compositions are further characterized in that they have a unimodal molecular weight distribution. Without intending to be bound by theory, this linearity in the polydispersity of the polymer compositions may result in a more regular polymer structure, which aids in the crystallization of the polymer chain. Due to this linearity, regular polymer structure, and crystallization of the polymer chain, a polymer composition according to this disclosure with a PDI of less than 1.1 may be a stronger polymer composition than a polymer composition with a PDI of greater than 1.1. Similarly, a polymer composition according to this disclosure with a PDI of less than 1.2 may be a stronger polymer composition than a polymer composition with a PDI of greater than 1.2. Similarly, a polymer composition according to this disclosure with a PDI of less than 1.4 may be a stronger polymer composition than a polymer composition with a PDI of greater than 1.4. Similarly, a polymer composition according to this disclosure with a PDI of less than 1.5 may be a stronger polymer composition than a polymer composition with a PDI of greater than 1.5. Similarly, a polymer composition according to this disclosure with a PDI of less than 2 may be a stronger polymer composition than a polymer composition with a PDI of greater than 2.

In some embodiments, the polycarbonate polyols include repeat units derived from epoxides that are not C2 symmetric. In these cases, the epoxide can be incorporated into the growing polymer chain in one of several orientations. The regiochemistry of the enchainment of adjacent monomers in such cases is characterized by the head-to-tail ratio of the composition.

In some embodiments the disclosure encompasses polycarbonate polyol compositions characterized in that, on average, more than about 80% of linkages between adjacent epoxide monomer units are head-to-tail linkages. In some embodiments, on average, more than 85% of linkages between adjacent epoxide monomer units are head-to-tail linkages. In some embodiments, on average, more than 90% of linkages between adjacent epoxide monomer units are head-to-tail linkages. In some embodiments, more than 95% of linkages between adjacent epoxide monomer units are head-to-tail linkages. In some embodiments, more than 99% of linkages between adjacent epoxide monomer units are head-to-tail linkages.

In some embodiments, the polycarbonate polyols include repeat units derived from epoxides that include a chiral center. In these cases, the epoxide can be incorporated into the growing polymer chain in defined orientations relative to adjacent monomer units. In some embodiments, the adjacent stereocenters are arranged randomly within the polymer chains. In some embodiments, the polycarbonate polyols are atactic. In other embodiments, more than about 60% of adjacent monomer units have the same stereochemistry. In some embodiments, more than about 75% of adjacent monomer units have the same stereochemistry. In some embodiments, more than about 85% of adjacent monomer units have the same stereochemistry. In some embodiments, more than about 95% of adjacent monomer units have the same stereochemistry. In some embodiments the polycarbonate polyols are isotactic. In other embodiments, more than about 60% of adjacent monomer units have the opposite stereochemistry. In some embodiments, more than about 75% of adjacent monomer units have the opposite stereochemistry. In some embodiments, more than about 85% of adjacent monomer units have the opposite stereochemistry. In some embodiments, more than about 95% of adjacent monomer units have the opposite stereochemistry. In some embodiments the polycarbonate polyols are syndiotactic.

In some embodiments, where a chiral epoxide is incorporated into the polycarbonate polyol compositions, the polymers are enantio-enriched. In other embodiments, where a chiral epoxide is incorporated into the polycarbonate polyol compositions, the polymers are not enantio-enriched.

In some embodiments, polycarbonate polyols include poly(ethylene carbonate). In other embodiments, polycarbonate polyols include poly(propylene carbonate). In other embodiments, polycarbonate polyols include poly(cyclohexene carbonate). In other embodiments, polycarbonate polyols include poly(epichlorohydrin carbonate). In some embodiments, polycarbonate polyols incorporate a glycidyl ether or glycidyl ester. In some embodiments, polycarbonate polyols incorporate phenyl glycidyl ether. In some embodiments, polycarbonate polyols include t-butyl glycidyl ether.

In embodiments, the polyol comprises triblock copolymers having a hydrophilic central block flanked by two polycarbonate chains with one or more terminal hydroxyl groups. In embodiments, the triblock copolymers have a polycarbonate or polyethercarbonate chain having 3 to about 500 repeating units and the hydrophilic middle block having from about 4 to about 200 repeating units. These polymers can have Mn of from 400-20,000 g/mol and more preferably Mn 500-5000 g/mol. In some embodiment the PDI is less than 2. In some PDI is less than 1.5. In some embodiment PDI is less than 1.2 or less than 1.1.

In some embodiments, polycarbonate polyols include poly(propylene-co-ethylene carbonate). In some embodiments, polycarbonate polyols include poly(propylene carbonate) incorporating from about 0.1 to about 10 wt. % of a C₄-C₃₀ epoxide. In some embodiments, polycarbonate polyols include poly(propylene carbonate) incorporating from about 0.1 to about 10% of a glycidyl ether. In some embodiments, polycarbonate polyols include poly(propylene carbonate) including from about 0.1 to about 10% of a glycidyl ester. In some embodiments, polycarbonate polyols include poly(ethylene carbonate) incorporating from about 0.1 to about 10% of a glycidyl ether. In some embodiments, polycarbonate polyols include poly(ethylene carbonate) incorporating from about 0.1 to about 10% of a glycidyl ester. In some embodiments, polycarbonate polyols include poly(ethylene carbonate) incorporating from about 0.1 to about 10% of a C₄-C₃₀ epoxide.

In some embodiments, the polycarbonate polyols incorporate one or more epoxides selected from the group consisting of: acetolactone, acevaltrate, allene oxide, allyl glycidyl ether, arene oxide, arglabin, benzene oxide, benzo[a]pyrene-7,8-dihydrodiol-9,10-epoxide, Bisphenol A diglycidyl ether, n-butyl glycidyl ether, coronaric acid (isoleukotoxin), cycloaliphatic epoxides, cyclohexene oxide, glycidic esters, diepoxybutane, diglycidyl ether, E-64, elephantopin, epichlorohydrin, epoxidized soybean oil, 3,4-epoxycyclohexanecarboxylate methyl ester, 3,4-epoxycyclohexylmethyl-3′,4′-epoxycyclohexane carboxylate (ECC), glycidic acid, glycidol, glycidyl methacrylate (GMA), hexafluoropropylene oxide (HFPO), oxiranol, α-propiolactone (2-methyl-α-lactone), propylene oxide (1,2-propylene oxide), styrene oxide, vernolic acid (leukotoxin), or 4-vinylcyclohexene dioxide (VCD). These epoxides may be aliphatic, optionally substituted heteroaliphatic, optionally substituted aryl fluoroalkyl, and optionally substituted heteroaryl.

In some embodiments, epoxide monomers incorporated into polycarbonate polyols include epoxides derived from naturally occurring materials such as epoxidized resins or oils. Examples of such epoxides include, but are not limited to: epoxidized soybean oil; epoxidized linseed oil; epoxidized octyl soyate; epoxidized PGDO; methyl epoxy soyate; butyl epoxy soyate; epoxidized octyl soyate; methyl epoxy linseedate; butyl epoxy linseedate; and octyl epoxy linseedate. These and similar materials are available commercially from Arkema Inc. under the trade name Vikoflex®. Examples of such commercially available Vikoflex® materials include Vikoflex 7170 epoxidized soybean oil, Vikoflex 7190 epoxidized linseed, Vikoflex 4050 epoxidized octyl soyate, Vikoflex 5075 epoxidized PGDO, Vikoflex 7010 methyl epoxy soyate, Vikoflex 7040 butyl epoxy soyate, Vikoflex 7080 epoxidized octyl soyate, Vikoflex 9010 methyl epoxy linseedate, Vikoflex 9040 butyl epoxy linseedate, and Vikoflex 9080 octyl epoxy linseedate. In some embodiments, the polycarbonate polyols incorporate epoxidized fatty acids.

In some embodiments, polycarbonate polyols incorporate epoxides derived from alpha olefins. Examples of such epoxides include, but are not limited to those derived from C₁₀ alphaolefin, C₁₂ alpha olefin, C₁₄ alpha olefin, C₁₆ alpha olefin, C₁₈ alpha olefin, C₂₀-C₂₄ alpha olefin, C₂₄-C₂₈ alpha olefin, and C₃₀₊ alpha olefins. These and similar materials are commercially available from Arkema Inc. under the trade name Vikolox®. In some embodiments, provided aliphatic polycarbonates derived from alpha olefins are heteropolymers incorporating other simpler epoxide monomers including, but not limited to: ethylene oxide, propylene oxide, butylene oxide, hexene oxide, cyclopentene oxide and cyclohexene oxide. These heteropolymers can include random co-polymers, tapered copolymers and block copolymers.

The method may further includes the steps of: a) providing a reaction mixture including one or more epoxides and one or more chain transfer agents having a plurality of sites capable of supporting the chain growth of CO₂ epoxide copolymers; b) contacting the reaction mixture with a metal complex, the metal complex including a metal coordination compound having a permanent ligand set and at least one ligand that is a polymerization initiator in the presence of carbon dioxide; c) allowing the polymerization reaction to proceed until a desired molecular weight of polymer has been formed; and d) terminating the polymerization.

In some embodiments, a chain transfer agent provided in step (a) of the method is any of the chain transfer agents described in this disclosure or mixtures of two or more of these. The chain transfer agent described in step (a) may include one or more polyhydric alcohols. In some embodiments, a polyhydric alcohol is a diol. In some embodiments, diols include but are not limited to: 1,2-ethanediol; 1,2-propanediol; 1,3-propanediol; 1,2-butanediol; 1,3-butanediol; 1,4-butanediol; 1,5-pentanediol; 2,2-dimethylpropane-1,3-diol; 2-butyl-2-ethylpropane-1,3-diol; 1,5-hexanediol; 1,6-hexanediol; 1,8-octanediol; 1,10-decanediol; 1,12-dodecanediol; 2,2,4,4-tetramethylcyclobutane-1,3-diol; 1,3-cyclopentanediol; 1,2-cyclohexanediol; 1,3-cyclohexanediol; 1,4-cyclohexanediol; 1,2-cyclohexanedimethanol; 1,3-cyclohexanedimethanol; 1,4-cyclohexanedimethanol; and 1,4-cyclohexanediethanol.

Other examples of chain transfer agents include the polyalkylene glycols such as: diethylene glycol, triethylene glycol, tetraethylene glycol, and other poly(ethylene glycol)s, such as those having number average molecular weights of from 220 to about 2000 g/mol, or those having an Mn of from 234 to about 2000 g/mol.

In some embodiments, diol chain transfer agents include hydroxyl-terminated polyolefins. Such materials include polymers sold by Sartomer Inc. under the trade name Krasol®. In other embodiments, diol chain transfer agents can include hydroxyl-terminated polyisobutylenes (PIB-diols and -triols) such as Polytail® H or Polytail® HA from Mitsubish Chemical Co. Other examples include hydroxyl-terminated polybutadienelstyrene(HTBS).

Yet other examples of suitable diols that may be provided in step (a) include 4,4′-(1-methylethylidene) biscyclohexanol; 2,2′-methylenebisphenol; 4,4′-methylenebisphenol; 4,4′-(phenylmethylene)bisphenol; 4,4′-(diphenylmethylene)bisphenol; 4,4′-(1,2-ethanediyl)bisphenol; 4,4′-(1.2-cyclohexanediyl)bisphenol; 4,4′-(1,3-cyclohexanediyl)bisphenol; 4,4′-(1,4-cyclohexanediyl)bisphenol; 4,4′-ethylidenebisphenol; 4,4′-(1-phenylethylidene)bisphenol; 4,4′-propylidenebisphenol; 4,4′-cyclohexylidenebisphenol; 4,4′-(1-methylethylidene)bisphenol; 4,4′-(1-methylpropylidene)bisphenol; 4,4′-(1-ethylpropylidene)bisphenol; 4,4′-cyclohexylidenebisphenol; 4,4′-(2,4,8,10-tetraoxaspiro5,5undecane-3,9-diyldi-2,1-ethanediyl)bisphenol; 1,2-benzenedimethanol; 1,3-benzenedimethanol; 1,4-benzenedimethanol; 4,4′-1,3-phenylenebis(1-methylethylidene)bisphenol; 4,4′-1,4-phenylenebis (1-methylethylidene)bisphenol; phenolphthalein; 4,4′-(1-methylidene)bis 2-methylphenol, 4,4′-(1-methylethylidene)bis2-(1-methylethyl)phenol; and 2,2′-methylenebis 4-methyl-6-(1-methylethyl)phenol.

In some embodiments, the chain transfer agent provided at step (a) is a polyhydric phenol derivative. In still other embodiments, a polyol is a carbohydrate. Examples of suitable carbohydrates include sugar alcohols, monosaccharides, disaccharides, oligosaccharides and polysaccharides and oligomers such as starch and starch derivatives.

In some embodiments, one —OH group of a diol is phenolic and the other is aliphatic. In other embodiments each hydroxyl group is phenolic. In some embodiments, the chain transfer agent is an optionally substituted catechol, resorcinol or hydroquinone derivative. In some embodiments, the —OH group may be an enol tautomer of a carbonyl group, a carbonyl hydrate or a hemiacetal.

In some embodiments, a chain transfer agent provided at step (a) includes a hydroxy acid. In some embodiments, a chain transfer agent includes a diacid. In some embodiments, diacid chain transfer agents include carboxy terminated polyolefin polymers. In some embodiments, carboxy terminated polyolefins include materials such as NISSO-PBC-series resins produced by Nippon Soda Co. Ltd. In some embodiments, a provided chain transfer agent is a hydroxy acid. In some embodiments where the provided chain transfer agent includes an acidic functional group, the compound is provided as a salt. In some embodiments, a carboxylic chain transfer agent is provided as an ammonium salt.

In some embodiments, a provided metal complex is a polymerization catalyst. In some embodiments, a polymerization catalyst with which the reaction mixture is contacted includes transition metal catalysts capable of catalyzing the copolymerization of carbon dioxide and epoxides.

In some embodiments, the metal complexes have the formula Lₚ-M-(L_{I})ₘ, where Lₚ is a permanent ligand set, M is a metal atom, and L_{I} is a ligand that is a polymerization initiator, and m is an integer between 0 and 2, inclusive representing the number of initiating ligands present.

In some embodiments, a metal atom, M, is selected from periodic table groups 3-13, inclusive. In some embodiments, M is a transition metal selected from periodic table groups 5-12, inclusive. In some embodiments, M is a transition metal selected from periodic table groups 4-11, inclusive. In some embodiments, M is a transition metal selected from periodic table groups 5-10, inclusive. In some embodiments, M is a transition metal selected from periodic table groups 7-9, inclusive. In some embodiments, M is selected from the group consisting of Cr, Mn, V, Fe, Co, Mo, W, Ru, Al, and Ni. In some embodiments, M is a metal atom selected from the group consisting of cobalt, chromium; aluminum; titanium, ruthenium, and manganese. In some embodiments, M is cobalt. In some embodiments, M is chromium. In some embodiments, M is aluminum.

In some embodiments, a metal complex is a zinc, cobalt, chromium, aluminum, titanium, ruthenium, or manganese complex. In some embodiments, a metal complex is an aluminum complex. In other embodiments, a metal complex is a chromium complex. In yet other embodiments, a metal complex is a zinc complex. In some other embodiments, a metal complex is a titanium complex. In still other embodiments, a metal complex is a ruthenium complex. In some embodiments, a metal complex is a manganese complex. In some embodiments, a metal complex is cobalt complex. In some embodiments where a metal complex is a cobalt complex, the cobalt metal has an oxidation state of +3 (Co(III)). In other embodiments, the cobalt metal has an oxidation state of +2 (Co(II)).

A permanent ligand set Lₚ includes one or more ligands that remain coordinated with a metal center throughout the catalytic cycle. This is in contrast to other ligands such as polymerization initiators, monomer molecules, polymer chains, and solvent molecules that may participate in the catalytic cycle or may be exchanged under the polymerization conditions.

In some embodiments, a permanent ligand set includes a single multidentate ligand that remains associated with the metal center during catalysis. In some embodiments, the permanent ligand set includes two or more ligands that remain associated with the metal center during catalysis. In some embodiments, a metal complex includes a metal atom coordinated to a single tetradentate ligand while in other embodiments, a metal complex includes a chelate including a plurality of individual permanent ligands. In some embodiments, a metal complex includes two bidentate ligands. In some embodiments, a metal complex includes a tridentate ligand.

In various embodiments, tetradentate ligands suitable for metal complexes may include, but are not limited to: salen derivatives, derivatives of salan ligands, bis-2-hydroxybenzamido derivatives, derivatives of the Trost ligand, porphyrin derivatives, derivatives of tetrabenzoporphyrin ligands, derivatives of corrole ligands, phthalocyaninate derivatives, and dibenzotetramethyltetraaza 14 annulene (TMTAA) derivatives.

In some embodiments, a permanent ligand set is a salen ligand. In some embodiments, a metal complex is a metallosalenate. In some embodiments, a metal complex is a cobalt salen complex. In some embodiments, a metal complex is a chromium salen complex. In other embodiments, a metal complex is an aluminum salen complex.

In some embodiments where the permanent ligand set includes a porphyrin ring, M is a metal atom selected from the group consisting of cobalt, chromium; aluminum; titanium, ruthenium, and manganese.

In addition to a metal atom and a permanent ligand set described in this disclosure, metal complexes suitable for polymerization systems optionally include one or more initiating ligands -L. In some embodiments, these ligands act as polymerization initiators and become a part of a growing polymer chain. In some embodiments, there is one initiating ligand present (m=1). In other embodiments, there are two initiating ligands present (m=2). In some embodiments, an initiating ligand may be absent (m=0). In some embodiments, a metal complex may be added to a reaction mixture without an initiating ligand, but may form a species in situ that includes one or two initiating ligands.

In some embodiments, -L_{I} is any anion. In some embodiments, -L_{I} is a nucleophile. In some embodiments, initiating ligands -L_{I} are nucleophiles capable of ring-opening an epoxide. In some embodiments, a polymerization initiator L_{I} is selected from the group consisting of azide, halides, alkyl sulfonates, carboxylates, alkoxides, and phenolates.

In some embodiments, initiating ligands include, but are not limited to, —OR^{x}, —SR^{X}, —OC(O)R^{x}, —OC(O)OR^{x}, —OC(O)N(R^{x}), —NR^{x}C(O)R^{x}, —CN, halo (such as —Br, —I, —Cl), —N₃, and —OSO₂R^{x} in which each R^{x} is, independently, selected from hydrogen, optionally substituted aliphatic, optionally substituted heteroaliphatic, optionally substituted aryl and optionally substituted heteroaryl and where two R^{x} groups can be taken together to form an optionally substituted ring optionally including one or more additional heteroatoms.

In some embodiments, -L_{I} is —OC(O)R^{x}, in which R^{x} is selected from optionally substituted aliphatic, fluorinated aliphatic, optionally substituted heteroaliphatic, optionally substituted aryl, fluorinated aryl, and optionally substituted heteroaryl. In some embodiments, -L_{I} is —OC(O)R^{x}, in which R^{x} is optionally substituted aliphatic. In some embodiments, -L_{I} is OC(O)R^{x}, in which R^{x} is optionally substituted alkyl or fluoroalkyl. In some embodiments, -L_{I} is —OC(O)CH₃ or —OC(O)CF₃.

Furthermore, in some embodiments, -L_{I} is —OC(O)R^{x}. in which R^{x} is optionally substituted aryl, fluoroaryl, or heteroaryl. In some embodiments, -L_{I} is —OC(O)R^{x}, in which R^{x} is optionally substituted aryl. In some embodiments, -L_{I} is —OC(O)R^{x}, in which R^{x} is optionally substituted phenyl. In some embodiments, -L_{I} is —OC(O)C₆H₅ or —OC(O)C₆F₅.

In some embodiments, -L_{I} is —OR^{x}, in which R^{x} is selected from optionally substituted aliphatic, optionally substituted heteroaliphatic, optionally substituted aryl, and optionally substituted heteroaryl. For example, in some embodiments, -L_{I} is —OR′, in which R′ is optionally substituted aryl. In some embodiments, -L_{I} is —OR′, in which R′ is optionally substituted phenyl. In some embodiments, -L_{I} is a 2,4-dinitrophenolate anion. In some embodiments, -L_{I} is —OC₆H₅. In some embodiments, -L_{I} is halo. In some embodiments, -L_{I} is —Br. In some embodiments, -L_{I} is —Cl. In some embodiments, -L_{I} is —I. In some embodiments, -L_{I} is —O(SO)R^{x}. In some embodiments -L_{I} is —OTs. In some embodiments -L_{I} is —OSOMe. In some embodiments -L_{I} is —OSO₂CF₃.

In some embodiments, metal complexes Lₚ-M-(L_{I})ₘ, include one or more initiating ligands -L_{I} characterized in that each ligand is capable of initiating two or more polymer chains. In some embodiments, the initiating ligand is any of the molecules previously described as being suitable as chain transfer agents. In some embodiments, an initiating ligand is an anion derived from any of the chain transfer agents described in this disclosure.

In some embodiments, a polymerization initiator -L_{I} includes a compound of the formula -Q′-A′-(Z)ₙ, in which: -Q′- is a carboxy or alkoxy group, -A′- is a covalent bond or a multivalent moiety, each Z is independently a functional group that can initiate a polymer chain, and n is an integer between 1 and 10 inclusive.

In some embodiments, the method further includes the use of at least one co-catalyst. In some embodiments, a co-catalyst is present. In some embodiments, the co-catalyst is selected from the group consisting of amines, guanidines, amidines, phosphines, nitrogen-including heterocycles, ammonium salts, phosphonium salts, arsonium salts, bisphosphine ammonium salts, and any combination of these.

In some embodiments, a co-catalyst is covalently linked to the permanent ligand set of the metal complex. In embodiments where a method includes a co-catalyst that is an “onium’ salt, there is necessarily an anion present to balance the charge of the salt. In some embodiments, this is any anion. In some embodiments, an anion is a nucleophile. In some embodiments, an anion is a nucleophile capable of ring-opening an epoxide. In some embodiments, an anion is selected from the group consisting of azide, halides, alkyl sulfonates, carboxylates, alkoxides, and phenolates. In some embodiments, methods include selected a catalyst and co-catalyst Such that the initiating ligand on the metal complex and an anion present to balance the charge of a cationic co-catalyst are the same molecule.

In some embodiments, the steps of any of the disclosed methods further include using one or more solvents. In some other embodiments, the polymerization steps are performed in neat epoxide without the addition of solvent. In some methods, where a polymerization solvent is present, the solvent is an organic solvent. In some embodiments, the solvent is a hydrocarbon. In some embodiments, the solvent is an aromatic hydrocarbon. In some embodiments, the solvent is an aliphatic hydrocarbon. In some embodiments, the solvent is a halogenated hydrocarbon. In some embodiments, the solvent is an ether. In some embodiments, the solvent is an ester. In some embodiments the solvent is a ketone.

In some embodiments suitable solvents include, but are not limited to: methylene chloride, chloroform, 1,2-dichloroethane, propylene carbonate, acetonitrile, dimethylformamide, n-methyl-2-pyrrolidone, dimethyl sulfoxide, nitromethane, caprolactone, 1,4-dioxane, and 1,3-dioxane. In some other embodiments, suitable solvents include, but are not limited to: methyl acetate, ethyl acetate, acetone, methyl ethyl ketone, propylene oxide, tretrahydrofuran, monoglyme triglyme, propionitrile, 1-nitropropane, cyclohexanone. In some embodiments, any of the disclosed methods include aliphatic oxide present in amounts concentrations between about 0.5 molar (M) to about 20 M or the neat concentration of the aliphatic oxide. In some embodiments, aliphatic oxide is present in amounts between about 0.5 M to about 2 M. In some embodiments, aliphatic oxide is present in amounts between about 2 M to about 5M. In some embodiments, aliphatic oxide is present in amounts between about 5 M to about 20 M. In some embodiments, aliphatic oxide is present in an amount of about 20 M. In some embodiments, liquid aliphatic oxide includes the reaction solvent.

In some embodiments, CO₂ is present at a pressure of between about 30 pounds per square inch (psi) to about 800 psi. In some embodiments, CO₂ is present at a pressure of between about 30 psi to about 500 psi. In some embodiments, CO₂ is present at a pressure of between about 30 psi to about 400 psi. In some embodiments, CO₂ is present at a pressure of between about 30 psi to about 300 psi. In some embodiments, CO₂ is present at a pressure of between about 30 psi to about 200 psi. In some embodiments, CO₂ is present at a pressure of between about 30 psi to about 100 psi. In some embodiments, CO₂ is present at a pressure of between about 30 psi to about 80 psi. In some embodiments, CO₂ is present at a pressure of about 30 psi. In some embodiments, CO₂ is present at a pressure of about 50 psi. In some embodiments, CO₂ is present at a pressure of about 100 psi. In some embodiments, the CO₂ is supercritical.

In some embodiments of the disclosed methods, the reaction is conducted at a temperature of between about 0° C. to about 150° C. In some embodiments, the reaction is conducted at a temperature of between about 23° C. to about 100° C. In some embodiments, the reaction is conducted at a temperature of between about 23° C. and about 80° C. In some embodiments, the reaction to be conducted at a temperature of between about 23° C. to about 50° C.

In some embodiments, a polymerization time is between about 30 minutes and about 48 hours. In some embodiments, the reaction is allowed to process for less than 24 hours. In some embodiments, the reaction is allowed to progress for less than 12 hours. In some embodiments, the reaction is allowed to process for between about 4 and about 12 hours.

In some embodiments, a polymerization reaction is allowed to proceed until the number average molecular weight of the polymers formed is between about 500 and about 400,000 g/mol. In some embodiments, the number average molecular weight is allowed to reach a value between 500 and 40,000 g/mol. In other embodiments, the number average molecular weight is allowed to reach a value between 500 and 20,000 g/mol. In some embodiments, the number average molecular weight is allowed to reach a value between 500 and 10,000 g/mol. In other embodiments, the number average molecular weight is allowed to reach a value between 500 and 5,000 g/mol. In other embodiments, the number average molecular weight is allowed to reach a value between 500 and 2,500 g/mol. In other embodiments, the number average molecular weight is allowed to reach a value between 1,000 and 5,000 g/mol.

In some embodiments, a polymerization reaction proceeds until between about 20% and about 100% of the provided epoxide is consumed. In some embodiments, the conversion is between about 40% and about 90%. In some embodiments, the conversion is at least 50%. In other embodiments, the conversion is at least 60%, at least 80% or at least 85%. In some embodiments, at least 80% of the provided epoxide is converted to polymer.

In some embodiments, a method further includes the step of choosing the ratios at which the catalyst, the chain transfer agent and the epoxide substrate are provided. In some embodiments, these ratios are selected to provide efficient epoxide conversion while providing polyol of the desired molecular weight in a selected length of time. In some embodiments, this selection of ratios includes the substeps of: (i) selecting a desired length of time for which the reaction is to be run; (ii) multiplying the selected length of time for which the polymerization reaction is to run by the turnover frequency of the catalyst under the reaction conditions; (iii) multiplying this result by the desired mole percent (mol. %) conversion of epoxide; and (iv) using the inverse of this result as the ratio of catalyst to epoxide used for the reaction. In some embodiments, the ratio of chain transfer agent to catalyst is determined by the additional following steps: (v) taking the value from step (iii) and multiplying this result by the molecular weight of the repeating unit of the polycarbonate; (vi) selecting a desired molecular weight for the polyol and dividing the result from step (v) by this number; and (vii) subtracting the number of chains produced per catalyst molecule from the result of step (vi) and taking the result as the ratio of chain transfer agent to catalyst to be used.

Isocyanates are organic compounds that include an isocyanate group, which is a functional group with the formula R—N═C═O. A diisocyanate is an isocyanate with two isocyanate groups. The diisocyanate and isocyanate monomers may be aliphatic or aromatic. Diisocyanates are manufactured for reactions with polyols or alcohols in the production of polyurethanes. The isocyanate and diisocyanate monomers may include at least one of methylene diphenyl diisocyanate, toluene diisocyanate, hexamethylene diisocyanate, isophorone diisocyanate, methyl isocyanate, toluene-2,4-diisocyanate, 1,5 naphthalene diisocyanate, diphenylmethane-2,4-diisocyanate, and diphenylmethane-2,2-diisocyanate. The isocyanate monomers may include diphenylmethane-2,2-diisocyanate. Not intending to be limited by theory, an isocyanate forms a urethane linkage upon treatment with an alcohol, with the reaction: ROH+R′NCO→ROC(O)N(H)R′ (where R and R′ are alkyl or aryl groups). Furthermore, if a diisocyanate is treated with a compound including two or more hydroxyl groups, such as a diol or a polyol, polymer chains, or polyurethanes, are formed.

In some embodiments, an amount of at least one of diisocyanate monomers or isocyanate monomers is from 50 to 150 weight percent (wt. %) greater than an amount of polyols. In some embodiments, the amount of diisocyanate or isocyanate monomers is from 15 to 45 wt. %, from 15 to 40 wt. %, from 15 to 35 wt. %, from 15 to 30 wt. %, from 15 to 25 wt. %, from 15 to 20 wt. %, from 20 to 45 wt. %, from 20 to 40 wt. %, from 20 to 35 wt. %, from 20 to 30 wt. %, from 20 to 25 wt. %, from 25 to 45 wt. %, from 25 to 40 wt. %, from 25 to 35 wt. %, from 25 to 30 wt. %, from 30 to 45 wt. %, from 30 to 40 wt. %, from 30 to 35 wt. %, from 35 to 45 wt. %, from 35 to 40 wt. %, or from 40 to 45 wt. % greater than an amount of polyols.

Forming the polyurethane proppant coating may further include adding an amine solution including ethylenediamine, propylenediamine, cyclohexadiamine, triethylenediamine, tetramethylethylenediamine, hexamethylenediamine, or combinations of these. The amine solution may include 1,6-hexamethylenediamine. In some embodiments, forming the polyurethane proppant coating may further include reacting the at least one of diisocyanate monomers and isocyanate monomers and the at least one of aliphatic fluorinated alcohols and fluorinated polyols with non-fluorinated polyols.

In another embodiment, the method includes forming the polyurethane proppant coating by reacting at least one of diisocyanate monomers or isocyanate monomers, and at least one of polycaprolactone polyols, polylactide polyols, poly(β-lactone) polyols, poly(s-lactone) polyols, polysulfide polyols, fluorinated vinyl ether polyols, siloxane polyols, or aminic polyols. The method then includes coating proppant particles with the polyurethane proppant coating to produce coated proppants with polyurethane proppant coating.

Coating the proppant particles may include mixing the proppant particles with the polyurethane proppant coating. In other embodiments, coating the proppant particles with polyurethane proppant coating includes coating the proppant particles with from 1 to 10 wt. % polyurethane proppant coating as calculated by a weight of the proppant particles.

Coating the proppant particles may also further include mixing the proppant particles, the polyurethane proppant coating, and a surfactant to prevent clumping. The surfactant may be anionic, cationic, zwitterionic, or nonionic. The anionic surfactants may include at least one of sulfate esters, sulfonate esters, phosphate esters, and carboxylates. The nonionic surfactants may include at least one of ethoxylates, fatty acid esters of polyhydroxy compounds, amine oxides, sulfoxides, and phosphine oxides. The ethoxylates may include at least one of fatty alcohol ethoxylates, alkylphenol ethoxylates, fatty acid ethoxylates, ethoxylated fatter esters, ethoxylated oils, ethoxylated amines, fatty acid amides, and terminally blocked ethoxylates. The fatty acid esters of polyhydroxy compounds may include at least one of fatty acid esters of glycerol, fatty acid esters of sorbitol, fatty acid esters of sucrose, and alkyl polyglucosides.

The method for producing coated proppants may include heating the proppant particles up to from 10° C. to 250° C., up to from 370° F. to 425° F., up to 50° F., up to 75° F., up to 100° F., up to 125° F., up to 150° F., up to 175° F., up to 200° F., up to 300° F., up to 350° F., up to 370° F., up to 400° F., up to 425° F., up to 450° F., or up to 500° F. before coating the proppant particles. The heating may include calcining by any suitable process such as by forced hot air heating, convection, conduction, combustion, exothermic reactions, microwave heating, or infrared radiation, for example.

In some embodiments, the coating step may include contacting the proppant particle with the mixture in a fluidized bed process. In some embodiments, the coating step may include a stationary, bubbling, circulation, or vibratory fluidized bed process. In some embodiments, the coating step may include spraying or saturating the proppant particles with the mixture. The coating step may include, in some embodiments, tumbling or agitating the coated proppants to prevent agglomeration or clumping. The coating step may include adding another compound to the mixture, such as a solvent, an initiator, an adhesion promoter, or an additive, to form the polyurethane proppant coating. In some embodiments, the coating process may be conducted with an emulsion coating technique. In some embodiments, the adhesion promoter may include a silane (for example, aminosilane) or a silane-including monomer. In some embodiments, an adhesion promoter may not be necessary to coat the proppant particles.

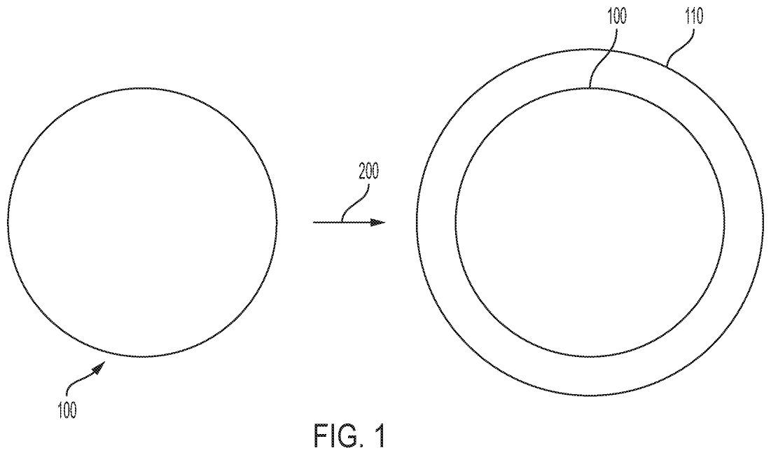

FIG. 1 schematically portrays two states of a proppant particle 100. On the left, an uncoated proppant 100 is depicted in a first, uncoated state. Then, on the right, a coated proppant is depicted in which the proppant particle 100 is in a second, coated state. In the second state, the proppant particle 100 has undergone a coating step 200 to be coated with a polyurethane proppant coating 110, forming a coated proppant.

The proppant particle may be chosen from any type of proppant suitable for use in hydraulic fracturing applications. As previously described, proppants are propping agent particles used in hydraulic fracturing fluids to maintain and hold open subsurface fractures during or following subsurface treatment. In some embodiments, the proppant particle may include particles of materials such as oxides, silicates, sand, ceramic, resin, epoxy, plastic, mineral, glass, or combinations of these. The proppant particles may include particles of bauxite, sintered bauxite, Ti⁴⁺/polymer composites, where the superscript “4+” stands for the oxidation state of titanium, titanium nitride (TiN), or titanium carbide. The proppant particles may include glass particles or glass beads. Embodiments of the present disclosure may utilize at least one proppant particle and in embodiments in which more than one proppant particle is used, the proppant particles may include a mixture of two or more different materials or three or more different materials.

The material of the proppant particle may be chosen based on the particular application and characteristics desired, such as the depth of the subsurface formation in which the proppant particles will be used, as proppant particles with greater mechanical strength are needed at greater lithostatic pressures. For instance, ceramic proppant materials exhibit greater strength, thermal resistance, and conductivity than sands. Additionally, ceramic proppant materials have more uniform size and shape than sands. Fully cured or partially cured unfunctionalized organic resin-coated sand may be chosen in embodiments to provide sand particles of irregular size and shape with greater crush resistance strength and conductivity.

The proppant particles may include various sizes or shapes. In some embodiments, the one or more proppant particles may have sizes from 140 mesh to 8 mesh (diameters from 106 micrometers (μm) to 2380 μm). In some embodiments, the proppant particles may have sizes from 8 mesh to 16 mesh (diam. 2380 μm to 1180 μm), 16 mesh to 30 mesh (diam. 600 μm to 1180 μm), 20 mesh to 40 mesh (diam. 420 μm to 840 μm), 30 mesh to 50 mesh (diam. 300 μm to 600 μm), 40 mesh to 70 mesh (diam. 212 μm to 420 μm) or 70 mesh to 140 mesh (diam. 106 μm to 212 μm). In some embodiments, individual proppant particles may have a diameter of from 100 to 3000 μm. The sphericity and roundness of the proppant particles may also vary based on the desired application.

In some embodiments, the method may further include roughening the proppant particles before the coating step. The proppant particles may have a rough surface texture that may increase adhesion of the polyurethane proppant coating to the proppant particle. The proppant particles surfaces may be roughened to increase the surface area of the proppant particle by any suitable physical or chemical method, including, for example, using an appropriate etchant. In some embodiments, the proppant particle may have a surface that provides a desired adhesion of the polyurethane proppant coating to the proppant particle or may already be sufficiently rough without a need for chemical or physical roughening. Specifically, ball milling proppant particles may provide relatively rounder particles as well as particles with increased surface roughness.

The term “rough” refers to a surface having at least one deviation from the normalized plane of the surface, such as a depression or protrusion. The surface may be uneven and irregular and may have one or more imperfections, such as dimples, bumps, projections or other surface defects. The rough surface may have an arithmetic average roughness (Rₐ) of greater than or equal to 1 nanometer (nm) (1 nm=0.001 micron (μm)). Rₐ is defined as the arithmetic average of the differences between the local surface heights and the average surface height and can be described by Equation 1, contemplating n measurements:

$${R}_{a} = \frac{2}{n} {\sum }_{i = 1}^{n} \vert {y}_{i} \vert \qquad EQUATION 1$$

In Equation 1, each yᵢ is the amount of deviation from the normalized plane of the surface (meaning the depth or height of a depression or protrusion, respectively) of the absolute value of the ith of n measurements. Thus, Rₐ is the arithmetic average of the absolute values of n measurements of deviation y from the normalized plane of the surface. In some embodiments, the surface of the proppant particle may have an Rₐ of greater than or equal to 2 nm (0.002 μm), or greater than or equal to 10 nm (0.01 μm), or greater than or equal to 50 nm (0.05 μm), or greater than or equal to 100 nm (0.1 μm), or greater than or equal to 1 μm.

Among other benefits, the polyurethane proppant coating may have hydrophobic or oleophobic characteristics, which reduces the interfacial tension and prevents condensate or water blockage in the wellbore, increasing gas relative permeability and thereby reducing condensate banking. Furthermore, hydrophobic characteristics mean that water will not wet the surface, which decreases the degradation of the proppants due to contact with water. These wettability characteristics enhance the load recovery of hydraulic fracturing fluid or water after fracturing operations as the hydrocarbons will experience less friction from contact with the proppant. This increases the rate of hydrocarbon production and the overall amount of hydrocarbon production.

The method may further include functionalizing the polyurethane proppant coating with fluoroalkane alcohols, fluoroether alcohols, fluorosulfonamide alcohols, hydrocarbons including more than 6 carbon atoms, silica groups, fluoro groups, perfluoro groups, or combinations of these to impart hydrophobicity to the polyurethane proppant coating. It may also be functionalized with di-alcohols, polyols, or both. Some examples of fluorinated di-alcohols include 4-fluororesorcinol, 2,2,3,3,4,4-hexafluoro-1,5-pentanediol, 1h,1h,10h,10h-hexadecafluoro-1,10-decanediol, hexafluoro-2,3-bis(trifluoromethyl)-2,3-butanediol, 2,2,3,3-tetrafluoro-1,4-butanediol, fluorinated oxetane polyol, 1,3-di(2-hydroxyhexafluoro-2-propyl)benzene, 1,4-di(2-hydroxyhexafluoro-2-propyl)benzene, tetrafluorore sorcinol, 4,4′-dihydroxyoctafluorobiphenyl, and combinations of these.

The fluoroalkane alcohols may include at least one of Zonyl® BA and Zonyl® BAL, produced by Sigma-Adrich. The fluoroalkane alcohol may include at least one of 2-(perfluoroalkyl)ethanol and may have a molecular weight of 443 grams per mole (g/mol). The fluoroalkane alcohol may have the formula F(CF₂)ₙCH₂CH₂OH, where n is 5, 6, 7, 8, 9, or 10. The fluoroalkane alcohol may be soluble in acetone, methyl ethyl ketone (butanone), and isobutyl alcohol. The fluoroalkane alcohol may have a viscosity of from 1 to 25 centiPoise (cP), from 1 to 20 cP, from 1 to 15 cP, from 1 to 10 cP, from 1 to 5 cP, from 5 to 25 cP, from 5 to 20 cP, from 5 to 15 cP, from 5 to 10 cP, from 10 to 25 cP, from 10 to 20 cP, from 10 to 15 cP, or from 15 to 25 cP at 30° C. The fluoroalkane alcohol may have a boiling point of from 145 to 245° C., and may include fluorine in an amount of from 40 to 90 wt. %, from 40 to 80 wt. %, from 40 to 75 wt. %, from 40 to 70 wt. %, from 40 to 65 wt. %, from 40 to 60 wt. %, from 40 to 50 wt. %, from 50 to 90 wt. %, from 50 to 80 wt. %, from 50 to 75 wt. %, from 50 to 70 wt. %, from 50 to 65 wt. %, from 50 to 60 wt. %, from 60 to 90 wt. %, from 60 to 80 wt. %, from 60 to 75 wt. %, from 60 to 70 wt. %, from 60 to 65 wt. %, from 65 to 90 wt. %, from 65 to 80 wt. %, from 65 to 75 wt. %, from 65 to 70 wt. %, from 70 to 90 wt. %, from 70 to 80 wt. %, from 70 to 75 wt. %, from 75 to 90 wt. %, from 75 to 80 wt. %, or of 70 wt. % as calculated by a weight of the fluoroalkane alcohol. The fluoroalkane alcohol may have a density of from 0.5 to 3 grams per milliLiter (g/mL), from 0.5 to 2 g/mL, from 0.5 to 1.5 g/mL, from 0.5 to 1 g/mL, 1 to 3 g/mL, from 1 to 2 g/mL, from 1 to 1.5 g/mL, from 1.5 to 3 g/mL, from 1.5 to 2 g/mL, from 2 to 3 g/mL, or of 1.7 g/mL.

The fluorosulfonamide alcohol may include Fluorad™ FC-10, produced by 3M™. The fluorosulfonamide alcohol may include the molecular formula C₁₂—H₁₀—F₁₇—N—O₃—S and a molecular weight of 571.247 grams per mole (g/mol).

The fluorinated polyols may include at least one of polyester polyols, polyether polyols, novolac polyols, resole polyols, and polyamide polyols. The fluorinated polyols may be aliphatic or aromatic. The fluorinated polyol may include Fluorobase® Z-1030, produced by Ausimont. The fluorinated polyol may include the molecular formula HO—CH2CF2(OCF2CF2)p(OCF2)qOCF2CH2-OH. The fluorinated polyol may include a hydroxyl equivalent weight of from 450 to 550 g/mol. The fluorinated polyol may have a viscosity of from 100 to 150 cP, a glass transition temperature of −100° C., and a density of 1.80 g/mL.

The polyurethane proppant coating may have a surface energy less than 50 milliJoules per square meter (mJ/m²), less than 40 mJ/m², less than 38 mJ/m², less than 37 mJ/m², less than 36 mJ/m², less than 35 mJ/m², less than 33 mJ/m², less than 31 mJ/m², less than 30 mJ/m², less than 29 mJ/m², less than 25 mJ/m², less than 20 mJ/m², less than 18 mJ/m², less than 15 mJ/m², less than 10 mJ/m², or less than 5 mJ/m².

The polyurethane proppant coating may have a glass transition temperature of from −10° C. to 200° C., from −10° C. to 150, from −10° C. to 100, from −10° C. to 70° C., from −10° C. to 50° C., from −10° C. to 47° C., from −10° C. to 45° C., from −10° C. to 40° C., from −10° C. to 25° C., from −10° C. to 20° C., from −10° C. to 15° C., from −10° C. to 5° C., from −10° C. to 0° C., from 0° C. to 100° C., from 0° C. to 70° C., from 0° C. to 50° C., from 0° C. to 47° C., from 0° C. to 45° C., from 0° C. to 40° C., from 0° C. to 25° C., from 0° C. to 20° C., from 0° C. to 15° C., from 0° C. to 5° C., from 5° C. to 100° C., from 5° C. to 70° C., from 5° C. to 50° C., from 5° C. to 47° C., from 5° C. to 45° C., from 5° C. to 40° C., from 5° C. to 25° C., from 5° C. to 20° C., from 5° C. to 15° C., from 15° C. to 100° C., from 15° C. to 70° C., from 15° C. to 50° C., from 15° C. to 47° C., from 15° C. to 45° C., from 15° C. to 40° C., from 15° C. to 25° C., from 15° C. to 20° C., from 20° C. to 100° C., from 20° C. to 70° C., from 20° C. to 50° C., from 20° C. to 47° C., from 20° C. to 45° C., from 20° C. to 40° C., from 20° C. to 25° C., from 25° C. to 100° C., from 25° C. to 70° C., from 25° C. to 50° C., from 25° C. to 47° C., from 25° C. to 45° C., from 25° C. to 40° C., from 40° C. to 100° C., from 40° C. to 70° C., from 40° C. to 50° C., from 40° C. to 47° C., from 40° C. to 45° C., from 45° C. to 100° C., from 45° C. to 70° C., from 45° C. to 50° C., from 45° C. to 47° C., from 47° C. to 100° C., from 47° C. to 70° C., from 47° C. to 50° C., from 50° C. to 100° C., from 50° C. to 70° C., or from 70° C. to 200° C. The glass transition temperature of a material characterizes the range of temperatures over which amorphous materials transition from a hard and relatively brittle “glassy” state into a viscous or rubbery state. This is a gradual and reversible transition.

Tensile strength is the resistance of a material to breaking under tension. A material with a greater tensile strength suffers less fracturing at a given tension as compared to a material with a lesser tensile strength. The polyurethane proppant coating may have a tensile strength of from 350 to 6600 psi, from 350 to 6200 psi, from 350 to 5500 psi, from 350 to 3500 psi, from 350 to 1500 psi, from 350 to 1000 psi, from 350 to 550 psi, from 550 to 6600 psi, from 550 to 6200 psi, from 550 to 5500 psi, from 550 to 3500 psi, from 550 to 1500 psi, from 550 to 1000 psi, from 1000 to 6600 psi, from 1000 to 6200 psi, from 1000 to 5500 psi, from 1000 to 3500 psi, from 1000 to 1500 psi, from 1500 to 6600 psi, from 1500 to 6200 psi, from 1500 to 5500 psi, from 1500 to 3500 psi, from 3500 to 6600 psi, from 3500 to 6200 psi, from 3500 to 5500 psi, from 5500 to 6600 psi, from 5500 to 6200 psi, or from 6200 to 6600 psi, meaning that the polyurethane proppant coating will not fracture until its tensile strength has been exceeded.

The coated proppants may include from 0.5 to 20 wt. %, from 0.5 to 15 wt. %, from 0.5 to 10 wt. %, from 0.5 to 8 wt. %, from 0.5 to 6 wt. %, from 0.5 to 5 wt. %, from 0.5 to 4.5 wt. %, from 0.5 to 2 wt. %, from 0.5 to 1 wt. %, 1 to 20 wt. %, from 1 to 15 wt. %, from 1 to 10 wt. %, from 1 to 8 wt. %, from 1 to 6 wt. %, from 1 to 5 wt. %, from 1 to 4.5 wt. %, from 1 to 2 wt. %, 2 to 20 wt. %, from 2 to 15 wt. %, from 2 to 10 wt. %, from 2 to 8 wt. %, from 2 to 6 wt. %, from 2 to 5 wt. %, from 2 to 4.5 wt. %, 1 to 2 wt. %, 4.5 to 20 wt. %, from 4.5 to 15 wt. %, from 4.5 to 10 wt. %, from 4.5 to 8 wt. %, from 4.5 to 6 wt. %, from 4.5 to 5 wt. %, 5 to 20 wt. %, from 5 to 15 wt. %, from 5 to 10 wt. %, from 5 to 8 wt. %, from 5 to 6 wt. %, 8 to 20 wt. %, from 8 to 15 wt. %, from 8 to 10 wt. %, from 10 to 15 wt. %, from 10 to 20 wt. %, or from 15 to 20 wt. % polyurethane proppant coating as calculated by a weight of the proppant particles.

In some embodiments, the method may further include mixing the polyurethane with resin to form a mixture and coating the proppant particles with the mixture. The polyurethane and resin may be uniformly distributed throughout the coating. The method for producing coated proppants may include coating the proppant particles using a two-layer coating or multi-layered coating system. The method may include coating the proppant particles with the resin, mixing the strengthening agent and the resin to form a mixture, and coating the proppant particles with the mixture. In another embodiment, the proppant particles may be coated with the resin prior to coating the proppant particles with the polyurethane proppant coating. These layers may be of uniform thickness or may include changes in thickness throughout, leading to hierarchical roughness in the polyurethane proppant coating. In some embodiments, the method may further include melting the resin prior to the coating step, in the case of a solid resin, such as novolac resin.

As used in this disclosure, a “resin”, which does not encompass the presently described polyurethanes, is a substance of plant or synthetic origin that is typically convertible into polymers, and may be a mixture of organic compounds such as terpenes, an organic compound produced by plants. The viscosity of resin may be greater than 20 cP, measured at a temperature of 120° C. In one embodiment, the resin may have no additional additives. The resin may include at least one of phenol, furan, epoxy, urethane, phenol-formaldehyde, polyester, vinyl ester, and urea aldehyde. The resin may include phenol-formaldehyde. The phenol-formaldehyde resin may include novolac resin or resole resin. Novolac resins are phenol-formaldehyde resins with a formaldehyde to phenol molar ratio of less than 1, where the phenol units are mainly linked by methylene or ether groups, or both. The novolac has a glass transition temperature greater than 250° F., 300° F., 350° F., 390° F., 400° F., 450° F., or 500° F. Novolac resins are stable, meaning that they do not react and do retain their polymer properties at temperatures of up to 300° F., 400° F., 425° F., 450° F., 475° F., 500° F., 550° F., or 600° F. Resole resins are phenol-formaldehyde resins with a formaldehyde to phenol molar ratio of more than 1, where the phenol units are mainly linked by methylene or ether groups, or both. This can harden without the addition of a crosslinking agent due to abundance of methylene to bridge the phenol groups.

The coated proppants may include from 0.5 to 20 wt. %, from 0.5 to 15 wt. %, from 0.5 to 10 wt. %, from 0.5 to 8 wt. %, from 0.5 to 6 wt. %, from 0.5 to 5 wt. %, from 0.5 to 4.5 wt. %, from 0.5 to 2 wt. %, from 0.5 to 1 wt. %, 1 to 20 wt. %, from 1 to 15 wt. %, from 1 to 10 wt. %, from 1 to 8 wt. %, from 1 to 6 wt. %, from 1 to 5 wt. %, from 1 to 4.5 wt. %, from 1 to 2 wt. %, 2 to 20 wt. %, from 2 to 15 wt. %, from 2 to 10 wt. %, from 2 to 8 wt. %, from 2 to 6 wt. %, from 2 to 5 wt. %, from 2 to 4.5 wt. %, 1 to 2 wt. %, 4.5 to 20 wt. %, from 4.5 to 15 wt. %, from 4.5 to 10 wt. %, from 4.5 to 8 wt. %, from 4.5 to 6 wt. %, from 4.5 to 5 wt. %, 5 to 20 wt. %, from 5 to 15 wt. %, from 5 to 10 wt. %, from 5 to 8 wt. %, from 5 to 6 wt. %, 8 to 20 wt. %, from 8 to 15 wt. %, from 8 to 10 wt. %, from 10 to 15 wt. %, from 10 to 20 wt. %, or from 15 to 20 wt. % resin as calculated by a weight of the proppant particles.

As stated previously, the method may further include adding a strengthening agent to the polyurethane proppant coating. A strengthening agent enhances the mechanical strength of the polyurethane proppant coating and provides resistance to chemicals used in hydraulic fracturing fluid. The strengthening agent may include at least one of glass fibers, carbon fibers, aramid fibers, carbon nanotubes, silica, alumina, mica, nanoclay, graphene, boron nitride nanotubes, vanadium pentoxide, zinc oxide, calcium carbonate, zirconium oxide, nanosilica, nanoalumina, nanozinc oxide, nanotubes, nanocalcium carbonate, and nanozirconium oxide. The strengthening agent may include carbon nanotubes. Carbon nanotubes include at least one of single-walled nanotubes, double-walled nanotubes, multi-walled carbon nanotubes, or narrow-walled nanotubes. The carbon nanotubes have a diameter of from 1 to 200 nm, from 20 to 100 nm, from 10 to 80 nm, from 4 to 20 nm, from 2 to 12 nm, from 2 to 10 nm, from 2 to 9 nm, from 2 to 8 nm, from 2 to 7 nm, from 2 to 6 nm, from 2 to 5 nm, from 2 to 4 nm, from 2 to 3 nm, from 3 to 12 nm, from 3 to 10 nm, from 3 to 9 nm, from 3 to 8 nm, from 3 to 7 nm, from 3 to 6 nm, from 3 to 5 nm, from 3 to 4 nm, from 4 to 12 nm, from 4 to 10 nm, from 4 to 9 nm, from 4 to 8 nm, from 4 to 7 nm, from 4 to 6 nm, from 4 to 5 nm, 5 to 12 nm, from 5 to 10 nm, from 5 to 9 nm, from 5 to 8 nm, from 5 to 7 nm, from 5 to 6 nm, from 6 to 12 nm, from 6 to 10 nm, from 6 to 9 nm, from 6 to 8 nm, from 6 to 7 nm, 7 to 12 nm, from 7 to 10 nm, from 7 to 9 nm, from 7 to 8 nm, from 8 to 12 nm, from 8 to 10 nm, from 8 to 9 nm, from 9 to 12 nm, from 9 to 10 nm, from 10 to 12 nm, or of 8 nm; a length of from 20 to 500 μm, from 20 to 200 μm, from 20 to 150 μm, from 20 to 100 μm, from 50 to 500 μm, from 50 to 200 μm, from 50 to 150 μm, from 50 to 100 μm, from 100 to 500 μm, from 100 to 200 μm, from 100 to 150 μm, from 150 to 500 μm, from 150 to 200 μm, or from 200 to 500 μm; an aspect ratio of from 100 to 50,000, from 500 to 30,000, from 1,000 to 20,000, from 1,000 to 100,000, from 1,000 to 50,000, from 1,000 to 40,000, from 1,000 to 30,000, from 1,000 to 25,000, from 1,000 to 20,000, from 1,000 to 15,000, from 1,000 to 12,000, from 1,000 to 10,000, from 1,000 to 8,000, from 8,000 to 100,000, from 8,000 to 50,000, from 8,000 to 40,000, from 8,000 to 30,000, from 8,000 to 25,000, from 8,000 to 20,000, from 8,000 to 15,000, from 8,000 to 12,000, from 8,000 to 10,000, from 10,000 to 100,000, from 10,000 to 50,000, from 10,000 to 40,000, from 10,000 to 30,000, from 10,000 to 25,000, from 10,000 to 20,000, from 10,000 to 15,000, from 10,000 to 12,000, from 12,000 to 100,000, from 12,000 to 50,000, from 12,000 to 40,000, from 12,000 to 30,000, from 12,000 to 25,000, from 12,000 to 20,000, from 12,000 to 15,000, from 15,000 to 100,000, from 15,000 to 50,000, from 15,000 to 40,000, from 15,000 to 30,000, from 15,000 to 25,000, from 15,000 to 20,000, from 20,000 to 100,000, from 20,000 to 50,000, from 20,000 to 40,000, from 20,000 to 30,000, from 20,000 to 25,000, from 25,000 to 100,000, from 25,000 to 50,000, from 25,000 to 40,000, from 25,000 to 30,000, from 30,000 to 100,000, from 30,000 to 50,000, from 30,000 to 40,000, from 40,000 to 50,000, from 40,000 to 100,000, or from 50,000 to 100,000; and a specific surface area of from 100 to 12,000 square meter per gram (m²/g), from 100 to 10,000 m²/g, from 100 to 800 m²/g, from 100 to 700 m²/g, from 400 to 12,000 m²/g, from 400 to 10,000 m²/g, from 400 to 800 m²/g, from 100 to 1,500 m²/g, from 120 to 1,000 m²/g, from 150 to 850 m²/g, or from 400 to 700 m²/g, where the specific surface area is calculated through the Brunauer-Emmett-Teller (BET) theory. The multi-walled carbon nanotubes have a metal oxide percentage of 10 wt. % or less, 5 wt. % or less, 3 wt. % or less, 2 wt. % or less, 1.5 wt. % or less, 1 wt. % or less, or 0.5 wt. % or less; and a bulk density of from 0.001 to 0.12 grams per cubic centimeter (g/cm³), from 0.01 to 0.08 g/cm³, from 0.02 to 0.06 g/cm³, from 0.01 to 1 g/cm³, from 0.01 to 0.5 g/cm³, from 0.01 to 0.2 g/cm³, from 0.01 to 0.1 g/cm³, from 0.01 to 0.05 g/cm³, from 0.01 to 0.02 g/cm³, from 0.02 to 1 g/cm³, from 0.02 to 0.5 g/cm³, from 0.02 to 0.2 g/cm³, from 0.02 to 0.1 g/cm³, from 0.02 to 0.05 g/cm³, from 0.05 to 1 g/cm³, from 0.05 to 0.5 g/cm³, from 0.05 to 0.2 g/cm³, from 0.05 to 0.1 g/cm³, from 0.06 to 0.08 g/cm³, from 0.1 to 1 g/cm³, 0.1 to 0.5 g/cm³, from 0.1 to 0.2 g/cm³, from 0.2 to 1 g/cm³, from 0.2 to 0.5 g/cm³, or from 0.5 to 1 g/cm³. The polyurethane proppant coating may include from 1 to 15 wt. %, from 1 to 12 wt. %, from 1 to 10 wt. %, from 1 to 8 wt. %, from 1 to 5 wt. %, from 5 to 15 wt. %, from 5 to 12 wt. %, from 5 to 10 wt. %, from 5 to 8 wt. %, from 8 to 15 wt. %, from 8 to 12 wt. %, from 8 to 10 wt. %, from 10 to 15 wt. %, from 10 to 12 wt. %, or from 12 to 15 wt. % of the strengthening agent, as calculated by a weight of the polyurethane proppant coating. The polyurethane proppant coating may include less than or equal to 20 wt. %, 15 wt. %, 10 wt. %, 5 wt. %, 2 wt. %, 1.5 wt. %, 1 wt. %, 0.75 wt. %, 0.5 wt. %, 0.2 wt. %, or 0.1 wt. % of the strengthening agent. The coated proppants may include from 0.1 to 10 wt. %, from 0.1 to 5 wt. %, from 0.1 to 3 wt. %, from 0.1 to 2 wt. %, from 0.1 to 1.5 wt. %, from 0.1 to 1 wt. %, from 0.1 to 0.5 wt. %, from 0.1 to 0.2 wt. %, 0.2 to 10 wt. %, from 0.2 to 5 wt. %, from 0.2 to 3 wt. %, from 0.2 to 2 wt. %, from 0.2 to 1.5 wt. %, from 0.2 to 1 wt. %, from 0.2 to 0.5 wt. %, from 0.5 to 10 wt. %, from 0.5 to 5 wt. %, from 0.5 to 3 wt. %, from 0.5 to 2 wt. %, from 0.5 to 1.5 wt. %, from 0.5 to 1 wt. %, from 1 to 10 wt. %, from 1 to 5 wt. %, from 1 to 5 wt. %, from 1 to 3 wt. %, from 1 to 2 wt. %, from 1 to 1.5 wt. %, from 1.5 to 10 wt. %, from 1.5 to 5 wt. %, from 1.5 to 3 wt. %, from 1.5 to 2 wt. %, from 2 to 10 wt. %, from 2 to 5 wt. %, from 2 to 3 wt. %, from 3 to 10 wt. %, from 3 to 5 wt. %, or from 5 to 10 wt. % strengthening agent as calculated by a weight of the polyurethane proppant coating.

The method may further include adding a tracer material to the polyurethane proppant coating. The suitable tracer material may include, but are not limited to, ionic contrast agents such as thorium dioxide (ThO₂), barium sulfate (BaSO₄), diatrizoate, metrizoate, iothalamate, and ioxaglate; and non-ionic contrast agents such as iopamidol, iohexol, ioxilan, iopromide, iodixanol, and ioversol. Furthermore, the tracer material may be present in a range of from 0.001 to 5.0 wt. %, from 0.001 to 3 wt. %, from 0.001 to 1 wt. %, from 0.001 to 0.5 wt. %, from 0.001 to 0.1 wt. %, from 0.005 wt. %, from 0.005 to 5.0 wt. %, from 0.005 to 3 wt. %, from 0.005 to 1 wt. %, from 0.005 to 0.5 wt. %, from 0.005 to 0.1 wt. %, from 0.01 to 5.0 wt. %, from 0.01 to 3 wt. %, from 0.01 to 1 wt. %, from 0.01 to 0.5 wt. %, from 0.5 to 5.0 wt. %, from 0.5 to 3 wt. %, from 0.5 to 1 wt. %, from 1 to 5.0 wt. %, from 1 to 3 wt. %, or from 3 to 5 wt. % as calculated by a weight of the polyurethane proppant coating.

The method may further include adding a coupling agent to the polyurethane proppant coating. A coupling agent is a compound that provides a chemical bond between two dissimilar materials, such as an inorganic material and an organic material. The coupling agent may form a bond between the proppant particle and the resin. The coupling agent may include at least one of epoxy, amino, aryl, and vinyl groups. In some embodiments, the coupling agent may include at least one of 3-glycidoxypropyltrimethoxysilane, 3-aminopropyltriethoxysilane, 3-aminopropyltrimethoxysilane, and 3-chloropropyltrimethoxysilane. The coupling agent may include from 0.1 to 20 volume percent (vol. %), from 0.1 to 15 vol. %, from 0.1 to 10 vol. %, from 0.1 to 5 vol. %, from 0.1 to 3 vol. %, from 0.1 to 1 vol. %, from 0.1 to 0.5 vol %, 0.1 to 20 vol. %, from 0.5 to 20 vol. %, from 0.5 to 15 vol. %, from 0.5 to 10 vol. %, from 0.5 to 5 vol. %, from 0.5 to 3 vol. %, from 0.5 to 1 vol. %, from 1 to 20 vol. %, from 1 to 15 vol. %, from 1 to 10 vol. %, from 1 to 5 vol. %, from 1 to 3 vol. %, from 3 to 20 vol. %, from 3 to 15 vol. %, from 3 to 10 vol. %, from 3 to 5 vol. %, from 5 to 20 vol. %, from 5 to 15 vol. %, from 5 to 10 vol. %, from 10 to 20 vol. %, from 10 to 15 vol. %, or from 15 to 20 vol. % 3-glycidoxypropyltrimethoxysilane and from 80 to 99.9 vol. %, from 80 to 99.5 vol. %, from 80 to 99 vol. %, from 80 to 95 vol. %, from 80 to 90 vol. %, from 80 to 85 vol. %, from 85 to 99.9 vol. %, from 85 to 99.5 vol. %, from 85 to 99 vol. %, from 85 to 95 vol. %, from 85 to 90 vol. %, from 90 to 99.9 vol. %, from 90 to 99.5 vol. %, from 90 to 99 vol. %, from 90 to 95 vol. %, 95 to 99.9 vol. %, from 95 to 99.5 vol. %, from 95 to 99 vol. %, from 99 to 99.9 vol. %, from 99 to 99.5 vol. %, from 99 to 99.9 vol. %, or from 99.5 to 99.9 vol. % deionized water. The polyurethane proppant coating may include from 0.001 to 20 wt. %, from 0.001 to 15 wt. %, from 0.001 to 10 wt. %, from 0.001 to 5 wt. %, from 0.001 to 2 wt. %, from 0.001 to 1 wt. %, from 0.001 to 0.2 wt. %, from 0.001 to 0.05 wt. %, from 0.05 to 20 wt. %, from 0.05 to 15 wt. %, from 0.05 to 10 wt. %, from 0.05 to 5 wt. %, from 0.05 to 2 wt. %, from 0.05 to 1 wt. %, from 0.05 to 0.2 wt. %, from 0.2 to 20 wt. %, from 0.2 to 15 wt. %, from 0.2 to 10 wt. %, from 0.2 to 5 wt. %, from 0.2 to 2 wt. %, from 0.2 to 1 wt. %, from 1 to 20 wt. %, from 1 to 15 wt. %, from 1 to 10 wt. %, from 1 to 5 wt. %, from 1 to 2 wt. %, from 2 to 20 wt. %, from 2 to 15 wt. %, from 2 to 10 wt. %, from 2 to 5 wt. %, from 5 to 20 wt. %, from 5 to 15 wt. %, from 5 to 10 wt. %, from 10 to 20 wt. %, from 10 to 15 wt. %, or from 15 to 20 wt. % coupling agent as calculated by a weight of the polyurethane proppant coating.

The method may further include adding a crosslinker to the polyurethane proppant coating. A crosslinker is a substance or agent that induces the subsurface formation of crosslinks. Mixing an unpolymerized or partially polymerized resin with a crosslinker results in a chemical reaction that crosslinks the resin. A crosslinked polyurethane proppant coating may retain its shape without dissolving in the hydraulic fracturing fluid, while maintaining a sufficient attraction or bond to the proppant particle. The degree of crosslinking may be controlled by the molar or weight ratio of crosslinker to monomer. In some embodiments, the crosslinker may include at least one of hexamethylenetetramine, paraformaldehyde, oxazolidines, melamine resins, aldehyde donors, or resole polymers. The coated proppant may include from 8 to 20 wt. %, from 8 to 18 wt. %, from 8 to 15 wt. %, from 10 to 20 wt. %, from 10 to 18 wt. %, from 10 to 16 wt. %, from 10 to 15 wt. %, from 13 to 20 wt. %, from 13 to 18 wt. %, or from 13 to 15 wt. % crosslinker as calculated by a weight of the polyurethane proppant coating.

In some embodiments, the method further includes adding a lubricating agent to the polyurethane proppant coating to reduce friction on the polyurethane proppant coating. The lubricating agent may include at least one of calcium stearate or silicone oil. The polyurethane proppant coating may include from 0.01 to 8 wt. %, from 0.01 to 3.75 wt. %, from 0.01 to 1.75 wt. %, from 0.25 to 8 wt. %, from 0.25 to 3.75 wt. %, from 0.25 to 1.75 wt. %, from 0.75 to 8 wt. %, from 0.75 to 3.75 wt. %, or from 0.75 to 1.75 wt. % lubricating agent as calculated by a weight of the polyurethane proppant coating.

The method may further include adding an accelerating agent to the polyurethane proppant coating. The accelerating agent may include at least one of hydrochloric acid, Lewis acid, boron trifluoride etherate, zinc or manganese ions, acetic acid, carboxylic acid, sodium hydroxide, bases, such as sodium hydroxide, or salts, such as zinc acetate. The polyurethane proppant coating may include from 1 to 70 wt. %, from 1 to 45 wt. %, from 1 to 20 wt. %, from 5 to 70 wt. %, from 5 to 45 wt. %, from 5 to 12 wt. %, from 12 to 70 wt. %, from 12 to 45 wt. %, from 12 to 20 wt. % accelerating agent as calculated by a weight of the proppant particles.

In other embodiments, the method includes coating proppant particles with a top coating. The top coating may be an overlying layer that may be added for additional properties or features. As a non-limiting example, additional coatings may be used in conjunction with, or may include, a breaker. As used throughout this disclosure, a “breaker” refers to a compound that may break or degrade the coating after a fracturing operation to prevent subsurface formation damage. In some embodiments, the breaker may be an oxidizer or enzyme breaker. The breaker may be any suitable materials capable of degrading a coating material.

The coated proppant may be at least one of hydrophobic and oleophobic. In some embodiments, the polyurethane proppant coating may have hydrophobic tendencies, such as a lack of attraction to water, repulsion to water, or immiscibility in water. The polyurethane proppant coating may not substantially dissolve (does not dissolve more than 10 wt. % or more than 8 wt. %, or more than 5 wt. % or more than 3 wt. %) when contacted with, submerged in, or otherwise exposed to water. In some embodiments, the polyurethane proppant coating may not dissociate from the proppant particle when the coated proppant is added to a water-based fluid, such as water or a fluid that includes water. Dissolution of the polyurethane proppant coating in a fluid medium may be determined by any suitable analytical technique for detection of solvated coating material that is performed on a fluid medium to which a coated proppant has been added and allowed to equilibrate at room temperature for at least 24 hours. The coated proppant may have a water contact angle of from 120° to 180°, of at least 70°, of at least 80°, of at least 90°, of at least 100°, of at least 110°, of at least 120°, of at least 150°, or of at least 180°. The contact angle may be measured in accordance with ASTM D7334-8(2013).

In some embodiments, the polyurethane proppant coating may have oleophobic tendencies, such as a lack of attraction to hydrocarbons, repulsion to hydrocarbons, or immiscibility in hydrocarbons. The polyurethane proppant coating may not substantially dissolve (does not dissolve more than 10 wt. % or more than 8 wt. %, or more than 5 wt. % or more than 3 wt. %) when contacted with, submerged in, or otherwise exposed to hydrocarbons. In some embodiments, the polyurethane proppant coating may not dissociate from the proppant particle when the coated proppant is added to a hydrocarbon-based fluid, oil or gas. Dissolution of the polyurethane proppant coating in a fluid medium may be determined by any suitable analytical technique for detection of solvated coating material that is performed on a fluid medium to which a coated proppant has been added and allowed to equilibrate at room temperature for at least 24 hours. The coated proppant may have a condensate contact angle of from 40° to 70°, of from 50° to 70°, of from 50° to 60°, of from 120° to 180°, of at least 70°, 80°, 90°, 100°, 110°, 120°, 150°, or of 180°. The coated proppant may have a hydrocarbon contact angle of from 40° to 70°, of from 50° to 70°, of from 50° to 60°, of from 120° to 180°, of at least 70°, 80°, 90°, 100°, 110°, 120°, 150°, or of 180°.

Referring again to FIG. 1, in one or more embodiments, the proppant particle 100 may be coated with a polyurethane proppant coating 110 during a coating step 200 to produce, form, or result in a coated proppant. In some embodiments, the polyurethane proppant coating 110 may be a surface layer on or bound to the proppant particle 100. Such a surface layer may coat at least a portion of the surface of the proppant particle 100. The polyurethane proppant coating 110 may coat the entire surface of the proppant particle 100 (as shown) or, alternatively, may only partially surround the proppant particle 100 (not shown), leaving at least a portion of surface of the proppant particle 100 uncoated or otherwise exposed. Also not shown, the polyurethane proppant coating 110 may be the outermost coating of the proppant particle with one or more other intervening coatings positioned between the polyurethane proppant coating 110 and the proppant particle 100. This means that in such an embodiment, the polyurethane proppant coating 110 is coupled to the proppant particle 100 as opposed to contacting the proppant particle 100 as shown in FIG. 1.

A hydraulic fracturing fluid and a method for increasing a rate of hydrocarbon production from a subsurface formation is also disclosed. A hydraulic fracturing fluid may be used to propagate fractures within a subsurface formation and further open fractures. The hydraulic fracturing fluid may include water, a clay-based component, and the coated proppants described in this disclosure. The clay-based component may include one or more components selected from the group consisting of lime (CaO), CaCO₃, bentonite, montmorillonite clay, barium sulfate (barite), hematite (Fe₂O₃), mullite (3Al₂O₃.2SiO₂ or 2Al₂O₃.SiO₂), kaolin, (Al₂Si₂O₅(OH)₄ or kaolinite), alumina (Al₂O₃, or aluminum oxide), silicon carbide, tungsten carbide, and combinations of these. Coated proppants within the hydraulic fracturing fluid may aid in treating subsurface fractures, to prop open and keep open the fracture. The method may include producing a first rate of production of hydrocarbons from the subsurface formation, in which the hydrocarbons have a first interfacial tension, introducing a hydraulic fracturing fluid including the coated proppants into the subsurface formation, in which the proppants reduce the first interfacial tension of the hydrocarbons to a second interfacial tension, thereby reducing condensate banking or water blockage near a wellbore, and increasing hydrocarbon production from the subsurface formation by producing a second rate of production of hydrocarbons from the subsurface formation, in which the second rate of production of hydrocarbons is greater than the first rate of production of hydrocarbons.

The hydraulic fracturing fluid in the subsurface fracture may include coated proppants suspended in the hydraulic fracturing fluid. In some embodiments, the coated proppants may be distributed throughout the hydraulic fracturing fluid. The coated proppants may not aggregate or otherwise coalesce within the subsurface formation, owing in part to the wettability characteristics of the polyurethane proppant coating. The hydraulic fracturing fluid may be pumped into the subsurface formation or may be otherwise contacted with the subsurface formation.

Embodiments of methods of treating a subsurface formation may include propagating at least one subsurface fracture in the subsurface formation to treat the subsurface formation. In some embodiments, the subsurface formation may be a rock or shale subsurface formation. In some embodiments, contacting of the subsurface formation may include drilling into the subsurface formation and subsequently injecting the hydraulic fracturing fluid into at least one subsurface fracture in the subsurface formation. In some embodiments, the hydraulic fracturing fluid may be pressurized before being injected into the subsurface fracture in the subsurface formation.

### Example

The following example illustrates features of the present disclosure but is not intended to limit the scope of the disclosure.

The properties of various polyurethane proppant coatings as described in this disclosure were tested and compared to the properties of conventional polyurethane coatings. The polyols used in the polyurethane coatings tested set forth in Table 1.

TABLE 1
Polyols used in various Polyurethane Coating Compositions

| | | Polypropylene | |
|---|---|---|---|
| | Hydroxyl | carbonate (PPC) | CO₂ Content |
| Polyol | Number | Content (%) | (wt. %) |
| Arcol | 57 | 0 | 0 |
| PPG2000 | | | |
| Stepanpol | 107 | 0 | 0 |
| PC-1011P-110 | | | |
| Polyol A | 112 | 90 | 40 |
| Polyol B | 106 | 80 | 30 |
| Polyol C | 56 | 95 | 40 |
| Polyol D | 67 | 80 | 30 |
| Polyol E | 56 | 50 | 20 |
| Polyol F | 56 | 45 | 20 |

Arcol PPG2000 includes polypropylene glycol (PPG) and is available from Bayer. Stepanpol PC-1011P-110 includes polydiethylene glycol adiapate and is available from Stepan. Polyols A, B, C, and D each include polypropylene carbonate (PPC), and Polyols E and F include a PPC-PPG-PPC triblock. Polyol E includes triblock copolymers of polypropylenecarbonate-block-polypropylene glycol-block-polypropylenecarbonate with two terminal hydroxyl groups. There are two hydroxyl groups. Polyol E has a molecular weight of about 2000 Daltons and includes approximately 50% PPC and 50% PPG. Polyol F includes triblock copolymers of polypropylenecarbonate-block-polypropylene glycol-block-polypropylenecarbonate with three terminal hydroxyl groups. Polyol F has a molecular weight of about 3000 Daltons and includes approximately 45% PPC and 55% PPG. Then, polyurethane coating compositions were created using the polyols in Table 1. 100 parts by volume polyol (and up to 5 parts by volume butanediol 1,4 (BDO), when used) were combined and heated in a vacuum oven at 80° C. and 23 Torr for 2 hours. Next, 0.0001 parts by volume Dabco® T12, a catalyst available from Evonik, was mixed into the 100 parts by volume polyol. Then, Lupranate® MP102, a 4,4-diphenylmethane diisocyanate available from BASF Polyurethanes, was added to the polyol and mixed by hand for 20 seconds. The mixture was then poured into a 9 inch by 9 inch silicone baking dish and spread evenly. BDO, a chain extender, was selectively added to the triblock polyols to increase the hardness and tensile strength values. The polyurethane coating compositions tested are set forth in Table 2.

TABLE 2
Various Polyurethane Coating Compositions

| | | Parts by | | | | | Glass |
|---|---|---|---|---|---|---|---|
| Polyurethane | | volume | Parts by | | | Tensile | Transition |
| Coating | Polyol | Lupranate | volume | Hardness | Hardness | Strength | Temperature |
| Compositions | Included | MP102 | BDO | (Shore A) | (Shore D) | (psi) | (° C.) |
| Comparative | Arcol | 18.7 | 0 | 20 | | | −43.2 |
| Composition | PPG2000 | | | | | | |
| 1A | | | | | | | |
| Comparative | Arcol | 26.8 | 2 | 20 | | | −39.3 |
| Composition | PPG2000 | | | | | | |
| 1B | | | | | | | |
| Comparative | Arcol | 39.2 | 5 | 25 | | 8.7 | −40.0 |
| Composition | PPG2000 | | | | | | |
| 1C | | | | | | | |
| Comparative | Stepanpol | 36.1 | 0 | 65 | 28 | 302 | −11.1 |
| Composition | PC-1011P-110 | | | | | | |
| 2 | | | | | | | |
| Example | Polyol A | 36.3 | 0 | | 82 | 6200 | 46.9 |
| Embodiment | | | | | | | |
| 1 | | | | | | | |
| Example | Polyol B | 36.2 | 0 | | 82 | 3280 | 46.4 |
| Embodiment | | | | | | | |
| 2 | | | | | | | |
| Example | Polyol C | 18.8 | 0 | | 81 | 5220 | 46.2 |
| Embodiment | | | | | | | |
| 3 | | | | | | | |
| Example | Polyol D | 22.3 | 0 | | 81 | 6540 | 37.5 |
| Embodiment | | | | | | | |
| 4 | | | | | | | |
| Example | Polyol E | 20.4 | 0 | 50 | | 58 | −3.7 |
| Embodiment | | | | | | | |
| 5A | | | | | | | |
| Example | Polyol E | 28.6 | 2 | 60 | 26 | 370 | 4.8 |
| Embodiment | | | | | | | |
| 5B | | | | | | | |
| Example | Polyol E | 40.9 | 5 | 85 | 44 | 913 | 13.3 |
| Embodiment | | | | | | | |
| 5C | | | | | | | |
| Example | Polyol F | 18.8 | 0 | 70 | 30 | 370 | −1.5 |
| Embodiment | | | | | | | |
| 6A | | | | | | | |
| Example | Polyol F | 26.9 | 2 | 75 | 34 | 501 | 2.7 |
| Embodiment | | | | | | | |
| 6B | | | | | | | |
| Example | Polyol F | 39.2 | 5 | 90 | 48 | 1450 | 20.5 |
| Embodiment | | | | | | | |
| 6C | | | | | | | |

The hardness was measured by Shore A or Shore D durometer. The Shore A scale is used for “softer” materials and the Shore D scale is used for “harder” materials. For example, a hardness of 60 on the Shore A scale corresponds to a hardness of 11 of the Shore D scale. Tensile strength was measured using an Instron instrument (ASTM D412, Die A). Thermal properties were measured by differential scanning calorimetry (20° C./minute) with T_{g} midpoint reported. Comparative Compositions 1A and 1B were too soft and sticky to measure tensile strength. Comparative Compositions 1C and 2 had a lesser tensile strength than all Example Embodiments except Example Embodiment 5A.

Example Embodiments 1, 2, 3, and 4, which were made with greater PPC content polyols (Polyols A, B, C, and D), exhibited a greater hardness than Example Embodiments 5A, 5B, 5C, 6A, 6B, and 6C, which were made with lesser PPC content polyols (Polyols E and F). Furthermore, Example Embodiments 1, 2, 3, and 4 exhibited a greater tensile strength and a greater glass transition temperature than Example Embodiments 5A, 5B, 5C, 6A, 6B, and 6C.

It should be apparent to those skilled in the art that various modifications and variations may be made to the embodiments described within without departing from the spirit and scope of the claimed subject matter. Thus, it is intended that the specification cover the modifications and variations of the various embodiments described within provided such modification and variations come within the scope of the appended claims and their equivalents.

Having described the subject matter of the present disclosure in detail and by reference to specific embodiments, it is noted that the various details disclosed within should not be taken to imply that these details relate to elements that are essential components of the various embodiments described within, even in cases where a particular element is illustrated in each of the drawings that accompany the present description. Further, it should be apparent that modifications and variations are possible without departing from the scope of the present disclosure, including, but not limited to, embodiments defined in the appended claims. More specifically, although some aspects of the present disclosure are identified as particularly advantageous, it is contemplated that the present disclosure is not necessarily limited to these aspects.

What is claimed is:

1. A method for producing coated proppants with a polyurethane proppant coating, the method comprising:
forming aliphatic polycarbonate polyols from the copolymerization of epoxide and CO₂ monomers;
forming the polyurethane proppant coating by reacting the aliphatic polycarbonate polyols and at least one of diisocyanate monomers and isocyanate monomers; and
coating proppant particles with the polyurethane proppant coating to produce coated proppants with polyurethane proppant coating.

2. The method of claim 1, in which forming aliphatic polycarbonate polyols from the copolymerization of epoxide and CO₂ monomers comprises:
reacting one or more epoxides and CO₂;
allowing the polymerization reaction to proceed until a desired molecular weight aliphatic polycarbonate polyol has formed and in which at least 90% of the end groups in the aliphatic polycarbonate polyol composition are hydroxyl groups; and
terminating the polymerization.

3. The method of claim 1, in which individual epoxide-CO₂ copolymers have:
a Mn of from 400 to 20,000;
greater than 90% carbonate linkages; and
at least 98% of the end groups being hydroxyl groups.

4. The method of claim 1, in which an amount of at least one of diisocyanate monomers or isocyanate monomers is from 50 to 150 wt. % greater than an amount of polyols.

5. The method of claim 1, in which forming the polyurethane proppant coating further comprises adding an amine solution comprising at least one of ethylenediamine, propylenediamine, cyclohexadiamine, triethylenediamine, tetramethylethylenediamine, hexamethylenediamine, or combinations of these.

6. The method of claim 1, in which coating the proppant particles with polyurethane proppant coating comprises coating the proppant particles with from 1 to 10 wt. % polyurethane proppant coating as calculated by a weight of the proppant particles.

7. The method of claim 1, further comprising heating the proppant particles up to from 10° C. to 250° C. before coating the proppant particles.

8. The method of claim 1, in which coating the proppant particles further comprises mixing the proppant particles, the polyurethane proppant coating, and a surfactant to prevent clumping.

9. The method of claim 1, in which the at least one of diisocyanate monomers and isocyanate monomers comprise at least one of toluene-2,4-diisocyanate; 1,5-naphthalene diisocyanate; diphenylmethane-2,4-diisocyanate; diphenylmethane-2,2-diisocyanate, or combinations of these.

10. The method of claim 1, further comprising coating the proppants with at least one of a lubricating agent, an additional resin, a coupling agent, a crosslinker, or a strengthening agent comprising at least one of glass fibers, carbon fibers, aramid fibers, mica, silica, alumina, carbon nanotubes, nanosilica, nanoalumina, nanozinc oxide, nanotubes, nanocalcium carbonate, or nanozirconium oxide.

11. The method of claim 10, in which the polyurethane proppant coating comprises from 1 to 15 wt. % strengthening agent.

12. The method of claim 1, further comprising functionalizing the polyurethane proppant coating with fluoroalkane alcohols, fluoroether alcohols, fluorosulfonamide alcohols, hydrocarbons comprising more than 6 carbon atoms, silica groups, fluoro groups, perfluoro groups, or combinations of these.

13. A method for producing coated proppants with a polyurethane proppant coating, the method comprising:
forming the polyurethane proppant coating by:
reacting at least one of diisocyanate monomers or isocyanate monomers, and
at least one of polyethercarbonate polyol, polycaprolactone polyols, polylactide polyols, poly(β-lactone) polyols, poly(s-lactone) polyols, polysulfide polyols, fluorinated vinyl ether polyols, siloxane polyols, or aminic polyols; and
coating proppant particles with the polyurethane proppant coating to produce coated proppants with polyurethane proppant coating.

14. The method of claim 13, further comprising functionalizing the polyurethane proppant coating with fluoroalkane alcohols, fluoroether alcohols, fluorosulfonamide alcohols, hydrocarbons comprising more than 6 carbon atoms, silica groups, fluoro groups, perfluoro groups, or combinations of these.

15. The method of claim 13, in which an amount of at least one of diisocyanate monomers or isocyanate monomers is from 50 to 150 wt. % greater than an amount of polyols.

16. The method of claim 13, in which forming the polyurethane proppant coating further comprises adding an amine solution comprising ethylenediamine, propylenediamine, cyclohexadiamine, triethylenediamine, tetramethylethylenediamine, hexamethylenediamine, or combinations of these.

17. The method of claim 13, in which coating the proppant particles with polyurethane proppant coating comprises coating the proppant particles with from 1 to 10 wt. % polyurethane proppant coating as calculated by a weight of the proppant particles.

18. The method of claim 13, in which coating the proppant particles further comprises mixing the proppant particles, the polyurethane proppant coating, and a surfactant to prevent clumping.

19. The method of claim 13, in which the at least one of diisocyanate monomers and isocyanate monomers comprise toluene-2,4-diisocyanate; 1,5-naphthalene diisocyanate; diphenylmethane-2,4-diisocyanate; diphenylmethane-2,2-diisocyanate; or combinations of these.

20. The method of claim 13, further comprising coating the proppants with at least one of a lubricating agent, an additional resin, a coupling agent, a crosslinker, or a strengthening agent comprising at least one of glass fibers, carbon fibers, aramid fibers, mica, silica, alumina, carbon nanotubes, nanosilica, nanoalumina, nanozinc oxide, nanotubes, nanocalcium carbonate, or nanozirconium oxide.
